(19) United States
(12) Patent Application Publication
(10) Pub. No.: US 2016/0287354 A1
(43) Pub. Date: Oct. 6, 2016

(54) SYSTEMS AND METHODS FOR ORTHODONTIC ARCHWIRES FOR MALOCCLUSIONS

(71) Applicant: SMARTER ALLOYS INC., Waterloo (CA)

(72) Inventors: Rodrigo F. VIECILLI, Redlands, CA (US); Mohammad Ibrahem KHAN, Waterloo (CA)

(21) Appl. No.: 15/091,204

(22) Filed: Apr. 5, 2016

Related U.S. Application Data
(60) Provisional application No. 62/143,727, filed on Apr. 6, 2015.
(60) Provisional application No. 62/163,338, filed on May 18, 2015.

(51) Int. Cl. A61C 7/00; A61C 7/14; G06F 17/50; A61C 7/20

(52) U.S. Cl. CPC A61C 7/002; A61C 7/20; A61C 7/14; G06F 17/5018

(57) ABSTRACT

A method and system for optimizing stiffness of an orthodontic archwire for a tooth malocclusion of a patient with a computer system, the method including: constructing a model of a patient's teeth in the computer system; inputting material properties of the archwire to the computer system; and determining an adjusted stiffness of a first section of the orthodontic archwire, the first section associated with the tooth malocclusion of the patient. In some cases, the adjusted stiffness may be determined based on different variables associated with the patient's teeth, which may include at least one of interbracket distance, malocclusion magnitude, bracket slot size, wire size, teeth size or extent of stiffness modification of the archwire.

### FIELD

Various embodiments disclosed herein relate to orthodontic devices, systems, and/or methods for optimizing material properties of an orthodontic archwire. In some embodiments, the devices, systems, and/or methods can include an orthodontic archwire having different archwire segments with varying stiffness.

### BACKGROUND

Currently, orthodontists use one of the following orthodontic archwire solutions for severe malocclusions: 1) Segmentation of the archwire and construction of customized appliances, which take considerable chair time and are prone to breakage and discomfort. 2) Use of multiple archwires (piggyback approach). A flexible archwire, usually a nickel titanium (NiTi) wire, is superposed on a higher stiffness archwire, usually a stainless steel (SS) wire, to achieve differential stiffness for the target area. This also requires more chair time and typically requires initial alignment so that the clinician can fit a SS (stainless steel) archwire on the anchorage teeth. 3) Triple force archwires—these are thermoelectrically treated NiTi wires that have progressively higher stiffness towards the posterior region of the arch. These archwires do not consider any of the clinical variables in our model except the size of the tooth. Hence, these archwires deliver random force values and do not have any publications validating their use.

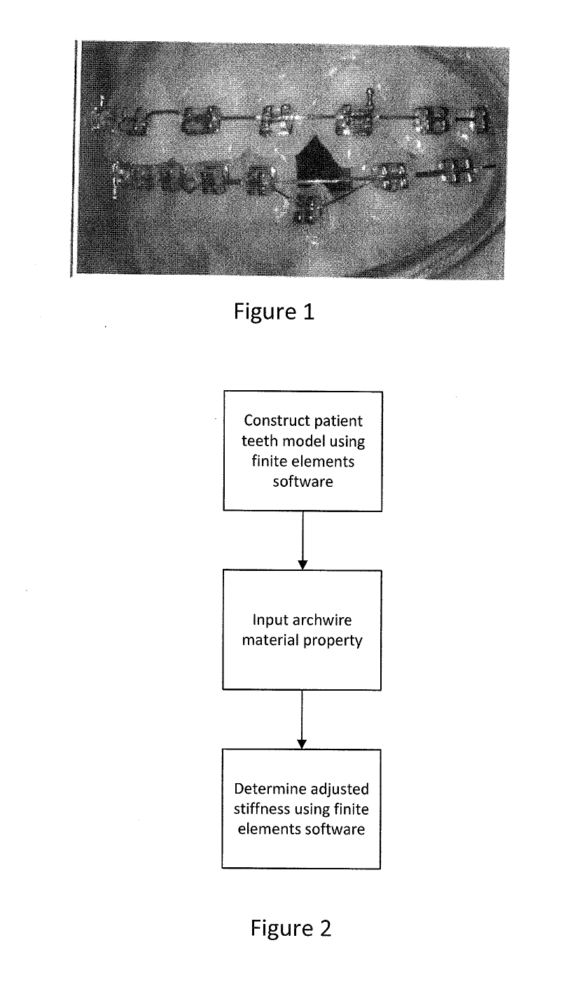

FIG. 1 illustrates a “low” canine. In such a case, the orthodontist is using two archwires (a high stiffness and a low stiffness). This allows a reasonable force level for the canine while it optimizes the anchorage of the adjacent teeth (so they will not move into the canine space as a reaction). Most likely, the orthodontist had to align the teeth separately before being able to set up this mechanism.

### SUMMARY

Using a single archwire with estimated (e.g., desired or predetermined) force levels on certain teeth (e.g., a canine) can require less orthodontist chair time and can allow the clinician to set up an archwire with less effort. According to the disclosure herein, a method, performed by a computer system, for optimizing stiffness of an orthodontic archwire (e.g., for severe malocclusions) can comprise a) constructing a model of a patient's teeth using a finite elements analysis software in the computer system. The method for optimizing stiffness of an orthodontic archwire can comprise b) inputting starting material properties of the archwire to the computer system. The archwire can comprise a plurality of archwire segments. The method for optimizing stiffness of an orthodontic archwire can comprise c) determining a first adjusted stiffness of each of the plurality of archwire segments by iteratively and systematically changing material properties of the archwire in the computer system.

The method for optimizing stiffness of an orthodontic archwire can comprise d) repeating operations a) to c) for different configurations for the patient's teeth to obtain a specific patient data, the different configurations comprising interbracket distance, malocclusion magnitude including rotation of the target tooth, bracket slot size, wire size, teeth size (e.g., target tooth size), and extent of stiffness modification to the wire. The method for optimizing stiffness of an orthodontic archwire can comprise e) determining a second adjusted stiffness of each of the plurality of archwire segments by comparing the specific patient data to existing data records using the computer system.

The method for optimizing stiffness of an orthodontic archwire can comprise applying different types of loads of the same magnitude on one or more teeth, the different types of loads comprising tipping forces, translation forces, and coupling forces. The method for optimizing stiffness of an orthodontic archwire can comprise calculating principal stress fields in the periodontal ligament using finite element models. The method for optimizing stiffness of an orthodontic archwire can comprise analyzing each tooth's dentoalveolar complex. The method for optimizing stiffness of an orthodontic archwire can comprise selecting a specific portion of the periodontal ligament for each tooth and averaging stress for substantially each, most, or some types of load.

The method for optimizing stiffness of an orthodontic archwire can comprise using a segment of 3 or more brackets, the brackets comprising the target tooth bracket and two or more supporting teeth bracket. The method for optimizing stiffness of an orthodontic archwire can comprise varying the spatial configuration of the target brackets for different combinations of the six Burstone geometries. The method for optimizing stiffness of an orthodontic archwire can comprise determining friction coefficients of wire segments based on experimental results and using the friction coefficient of the wire segments.

The method for optimizing stiffness of an orthodontic archwire can comprise obtaining load-deflection curve of the archwire using nonlinear finite element method calculations by loading a target tooth to a specific position and unloading the target tooth to its initial position in the computer system.

The method for optimizing stiffness of an orthodontic archwire can comprise using finite elements analysis to obtain a target force of a reference tooth. The method for optimizing stiffness of an orthodontic archwire can comprise a target force, wherein the target force of a reference tooth comprises a force applied by a 0.014 inch NiTi wire (or other suitable material wire). The method for optimizing stiffness of an orthodontic archwire can comprise a target force, wherein the target force of a reference tooth comprises a proposed biomechanically optimized force magnitude related to production of a specific stress pattern in an animal model. The method for optimizing stiffness of an orthodontic archwire can comprise a target force, the target force of a reference tooth comprising a proposed biomechanically optimized force magnitude related to production of a tissue response of in animal model.

The method for optimizing stiffness of an orthodontic archwire can comprise averaging periodontal ligament stresses for one or more loads to the averaging periodontal ligament stresses to the reference tooth to yield periodontal ligament tooth resistance numbers. The method for optimizing stiffness of an orthodontic archwire can comprise using the tooth resistance numbers as reference numbers to establish desired forces to be applied to teeth.

The method for optimizing stiffness of an orthodontic archwire can comprise f) using the material property determined in steps c) or e) to construct a modified archwire model. The method for optimizing stiffness of an orthodontic archwire can comprise iterating the material properties of each of the plurality of wire segments until the desired material property of each of the plurality of wire segments that delivers the desired load proportions to the patient's teeth is achieved.

The method for optimizing stiffness of an orthodontic archwire can comprise g) manipulating the archwire in the laboratory to yield the desired material properties. The method for optimizing stiffness of an orthodontic archwire can comprise h) manufacturing the archwire having the desired material properties.

The method for optimizing stiffness of an orthodontic archwire can comprise operations g) or f), wherein operations g) or f) comprise softening stiffness of one or more of the plurality of archwire segments by modifying diameter of the one or more segments The method for optimizing stiffness of an orthodontic archwire can comprise an archwire, wherein the archwire comprises soft segments and stiff segments, the stiff segments configured to substantially prevent, inhibit, or mitigate unnecessary movement of reactive teeth.

According to one aspect herein, there is provided a method for optimizing stiffness of an orthodontic archwire for a tooth malocclusion of a patient with a computer system, the method including: constructing a model of a patient's teeth in the computer system; inputting material properties of the archwire to the computer system; and determining an adjusted stiffness of a first section of the orthodontic archwire, the first section associated with the tooth malocclusion of the patient.

In one case, the method may further include: wherein the adjust stiffness is determined based on different variables associated with the patient's teeth. In this case, the variables may include at least one of interbracket distance, malocclusion magnitude, bracket slot size, wire size, teeth size or extent of stiffness modification of the archwire.

In another case, the method may include: wherein the adjusted stiffness is determined based on a comparison of the model of the patient's teeth to a patient database including data for addressing tooth malocclusions.

In yet another case, the method may further include constructing an archwire having the first section based on the adjusted thickness.

In the above cases, the method may involve wherein determining the adjusted stiffness may include iteratively changing the material properties of the archwire in the computer system.

Also in the above cases, the method may further include reducing a diameter of the first section of the archwire relative to other portions of the archwire to soften the first section of the archwire relative to the other portions of the archwire. In this situation, the method may be such that wherein the adjusted stiffness of the first section varies through an extent of the first section.

In the above cases, the archwire may include a second section, the second section having a stiffness higher than the first section. In this case, the archwire may include a third section, the third section having a stiffness higher than the first section, wherein the first section is between the second and third sections. Further, a first portion of the adjusted thickness of the first section proximate to the second section may be stiffer than a second portion of the adjusted thickness of the first section proximate to the third section. Still further, an interbracket distance associated with the first portion of the first section may be less than an interbracket distance associated with the second portion of the first section. In these situations, the stiffness of the second section may be substantially same as the stiffness of the third section.

In the above cases, the adjusted stiffness may be determined using finite element analysis in the computer system.

In the above cases, the patient's teeth may include a problem area and an anchoring area, and the archwire may be configured such that the first section is located on or near the problem area and the second section is on or near the anchoring area.

In the above cases, the archwire may include a material of nickel titanium.

Also in the above cases, the stiffness of the archwire may be changed within 2 micrometer resolution without making any bends.

Still further, a stiffness modification of the archwire may reduce height of the martensitic transformation curve.

Yet still further, a stiffness modification of the archwire may reduce height of the austenitic transformation curve.

Still further, a stiffness modification of the archwire may reduce unloading plateau of the archwire from about 8 times to about 11 times.

Still further, a stiffness modification of the archwire reduces loading plateau of the archwire from about 1.5 times to about 2.5 times.

Still further, a stiffness modification provides sufficient force to allow movement of the maloccluded tooth while opening space by moving adjacent teeth.

In the above cases, constructing a model of a patient's teeth may include calibrating a finite element model using a plurality of brackets, such as, for example, three brackets.

In the above cases, a friction coefficient may be reduced during movement of the tooth to allow for sliding at larger activations by using a SS ligature and tying the archwire to the bottom of the bracket.

In the above cases, the method may involve ligating canine displacement from a distance and not inserting the wire in a slot of a bracket.

In the above cases, the method may include using 0.018 CuNiTi archwire.

In the above cases, the method may be performed by a processor in a computing device making use of a digital memory and other computer components and, may include adjusting the variables using an input device.

Also in the above cases, the method may include calculating resistance factors of the tooth-periodontal ligament-bone complex to different tooth movements based on average teeth using finite elements analysis.

In some cases, the calculating resistance factors may include using the most negative stress as a principal stress when necrosis is absent.

In some cases, the calculating resistance factors may include using the most compressive stress when necrosis is present.

In the above cases, the method may include using finite elements analysis to change the material at each interbracket distance starting from lower incisors until a desired force proportion is achieved between substantially all teeth.

According to another aspect herein, there is provided a system configured to perform the operations of the above method(s), the system comprising, in various embodiments, a processor, memory, software modules, input and output devices, lasers, fixtures, and the like.

DESCRIPTION OF THE DRAWINGS

FIG. 1 illustrates a “low” canine.

FIG. 2 shows an example block diagram for a method of optimizing stiffness of an orthodontic archwire with a computer system.

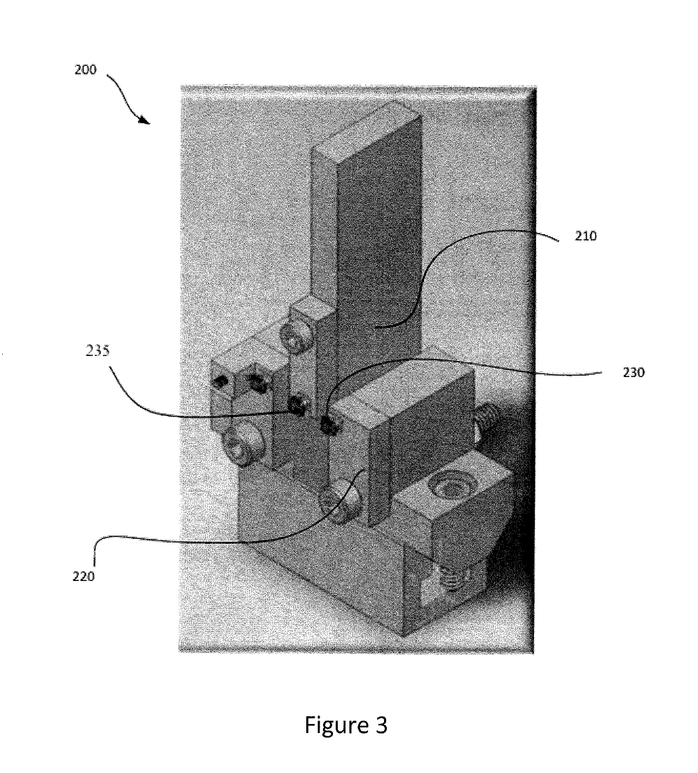

FIG. 3 shows an example drawing of an experimental setup for calibrating a finite elements model having three brackets.

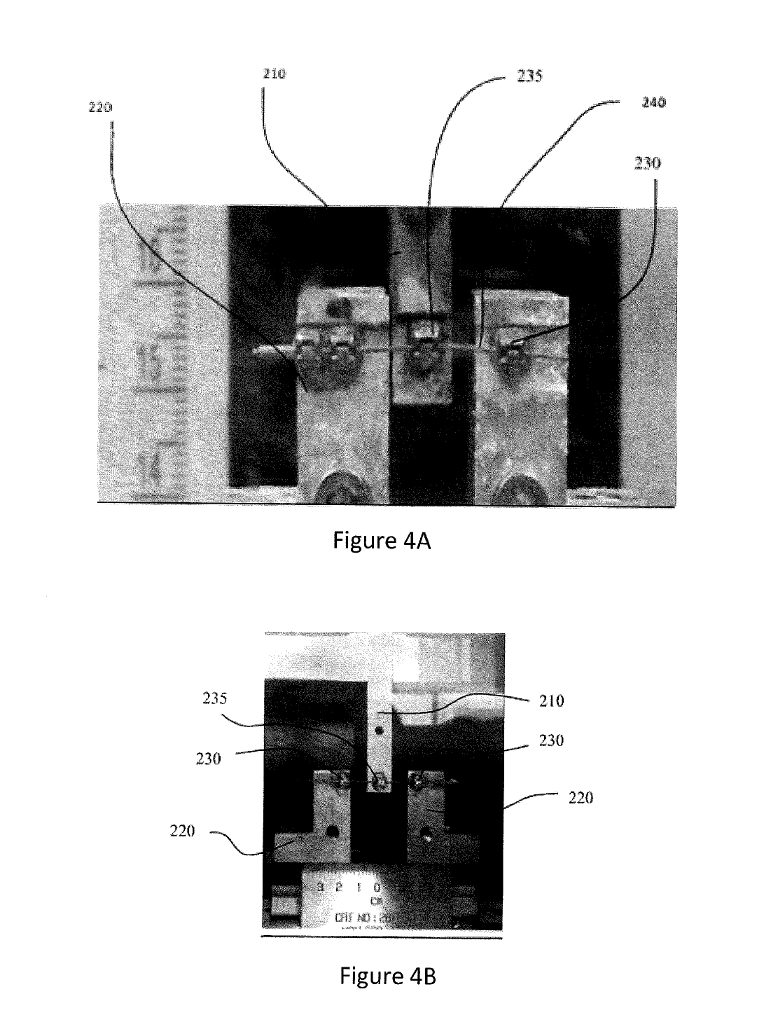

FIGS. 4A and 4B show photographs of the experimental setup 200 of FIG. 3.

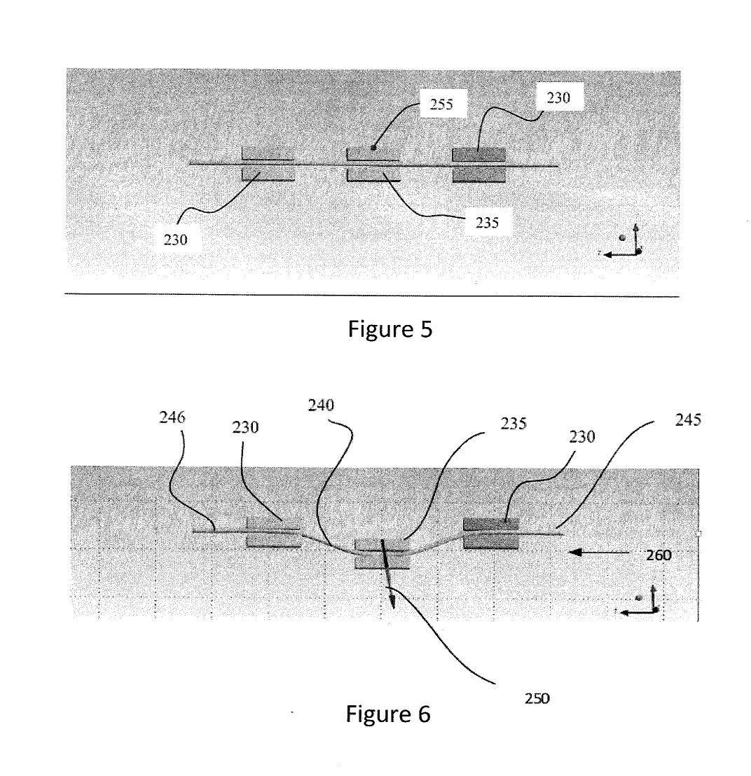

FIG. 5 shows a schematic model of the experimental setup 200 of FIG. 3.

FIG. 6 shows the model of the experimental setup 200 of FIG. 3 with a force 250 applied.

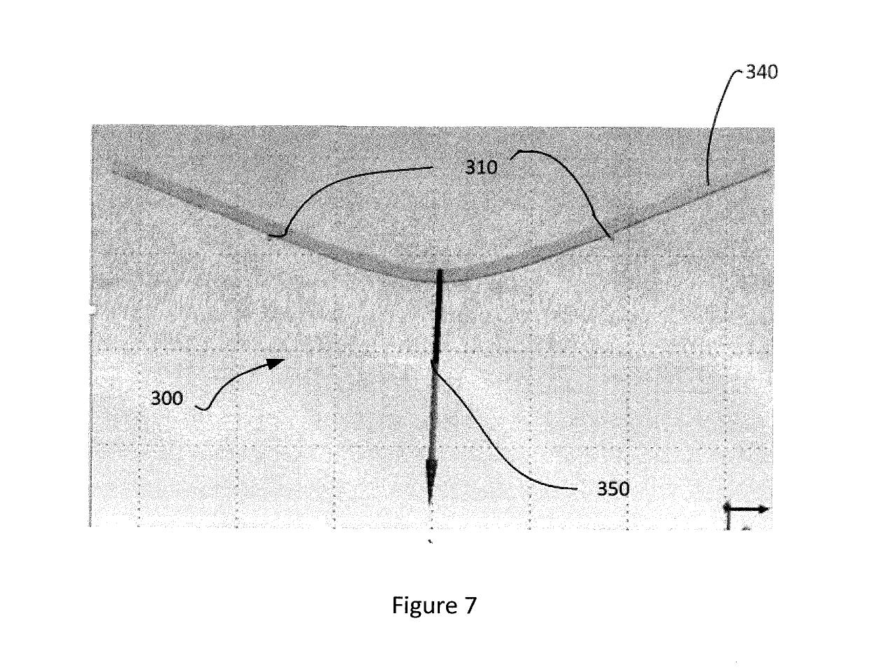

FIG. 7 shows a schematic diagram of an example model of 3-point bending.

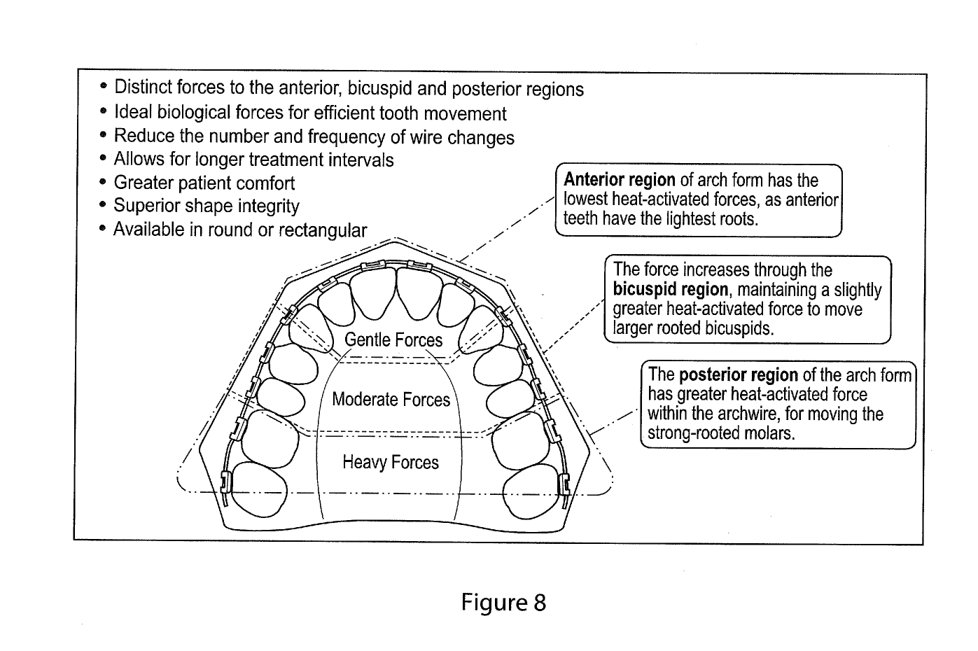

FIG. 8 shows different parts of the mouth in relation to forces on teeth.

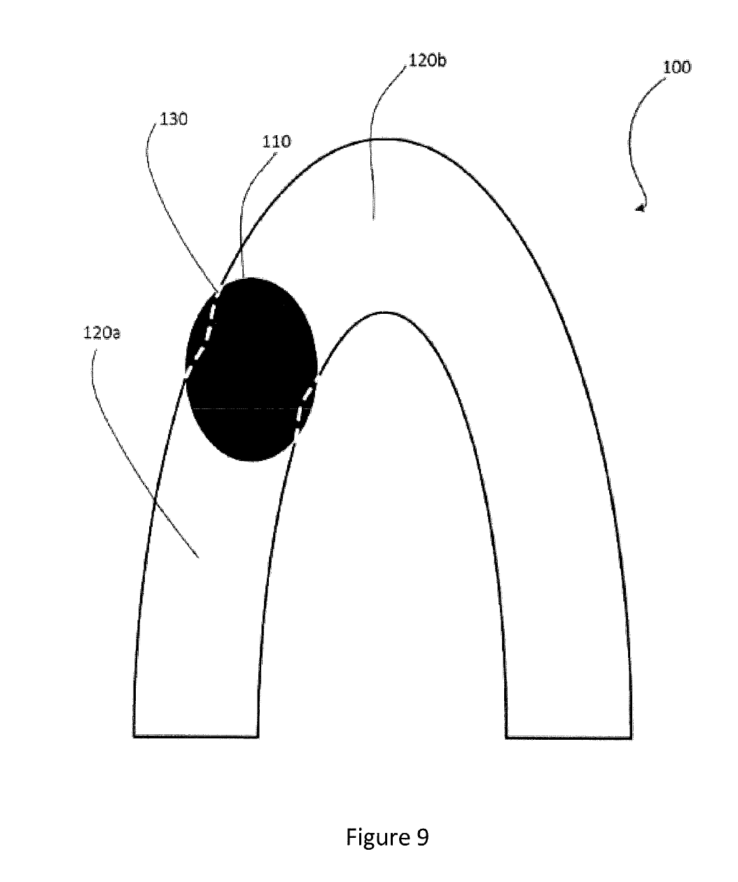

FIG. 9 shows an example schematic diagram of an archwire having a soft section and a stiff section.

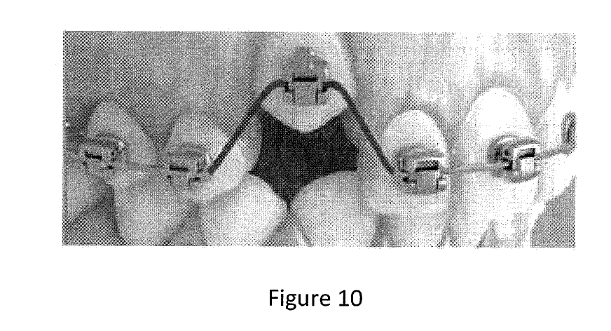

FIG. 10 shows an example drawing of archwire having a soft section and a stiff section inserted to a slot of a bracket on the maloccluded tooth.

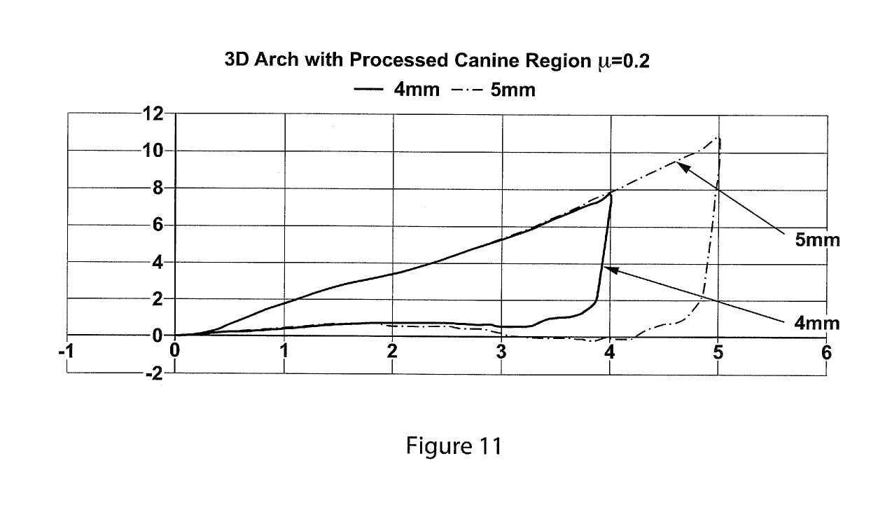

FIG. 11 shows a graph showing difference in behavior of a 3D archwire with processed canine region having different activations.

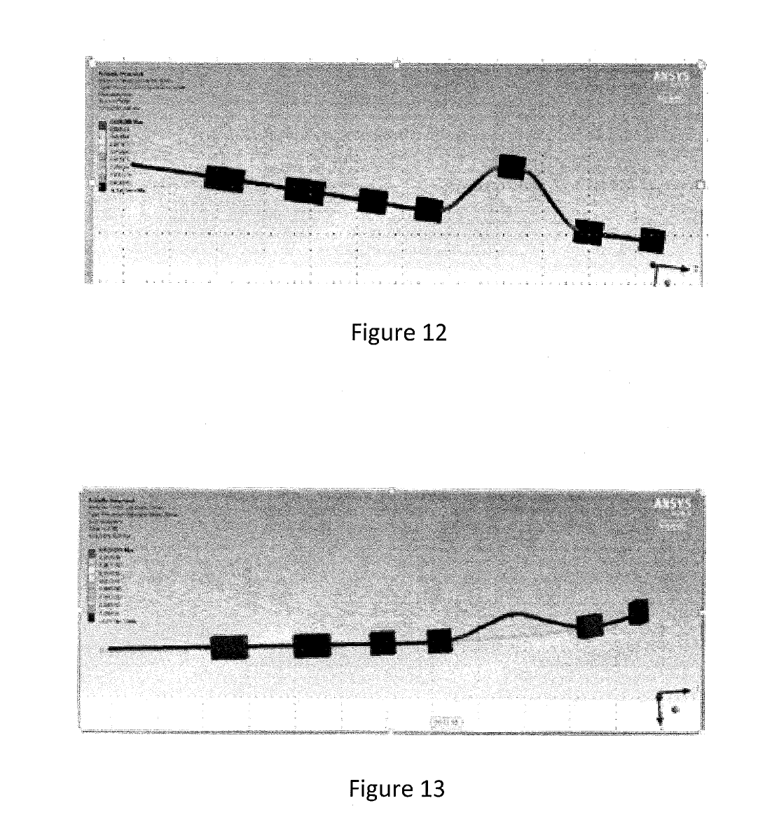

FIG. 12 shows a schematic model drawing of a 3D archwire inserted to a slot of a bracket.

FIG. 13 shows a schematic model drawing of a 3D archwire simulating a larger activation.

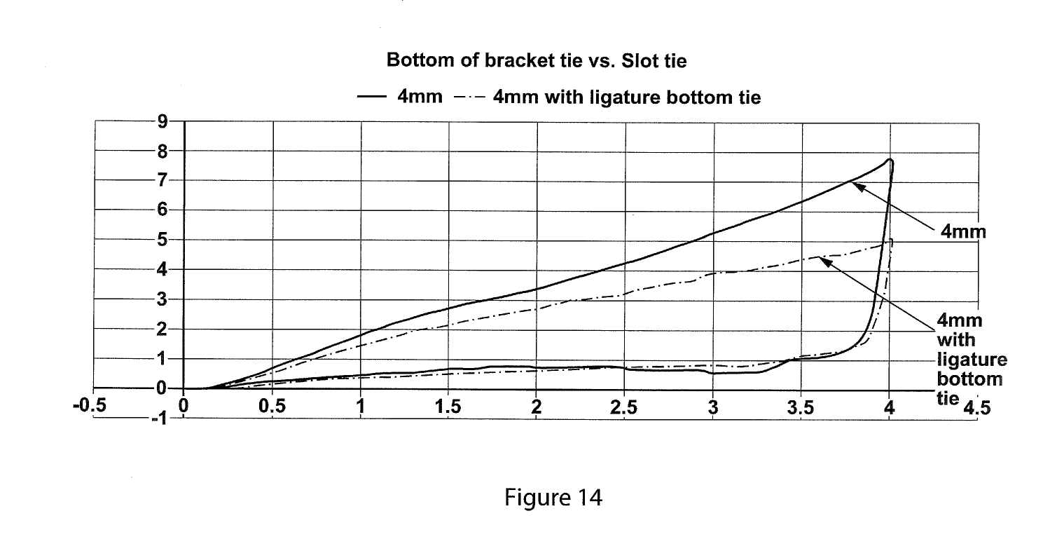

FIG. 14 shows a graph comparing the archwire ligated to the bottom of the bracket versus the archwire ligated to the slot.

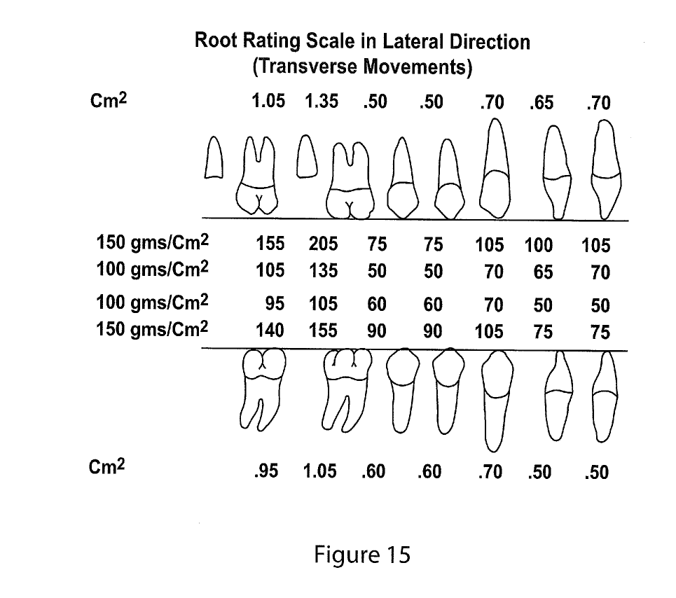

FIG. 15 shows a root rating scale.

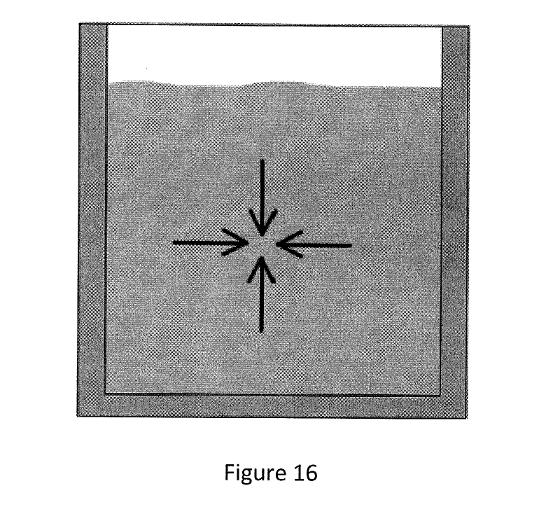

FIG. 16 shows hydrostatic pressure.

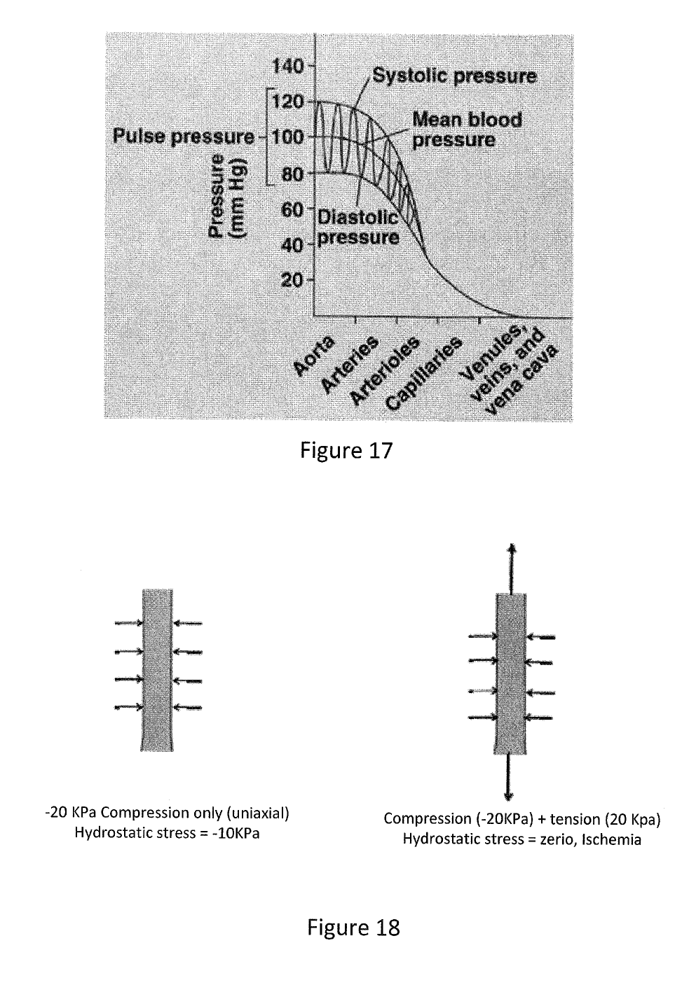

FIG. 17 shows that blood pressure can vary from 1.3 to 4 KPa in capillaries and 4 to 15 KPa in arterioles.

FIG. 18 shows that even when hydrostatic PDL stress (average of three principal stresses) is zero, ischemia can still occur.

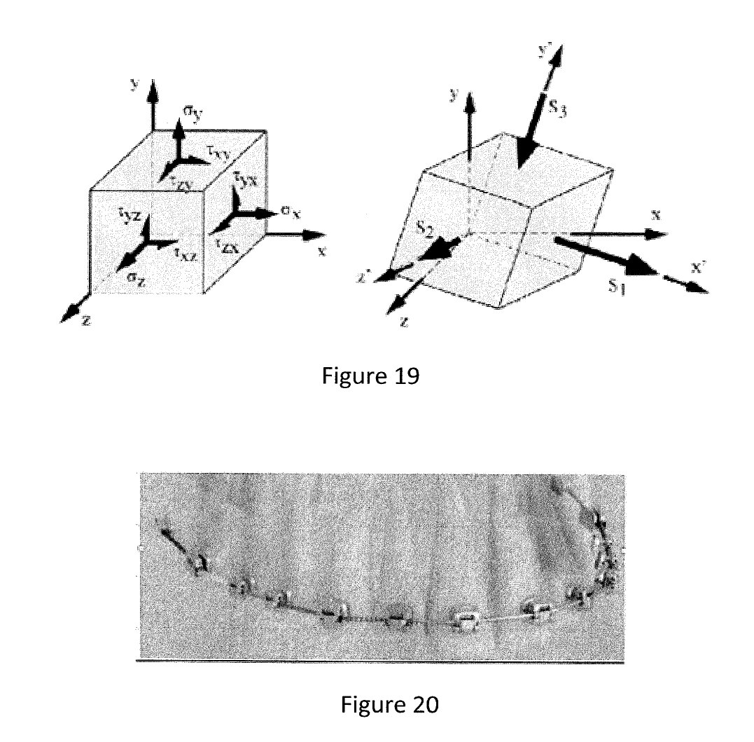

FIG. 19 illustrates simplified 3D stresses.

FIG. 20 shows an example drawing of an archwire having optimized force proportions across substantially all, most, or some teeth.

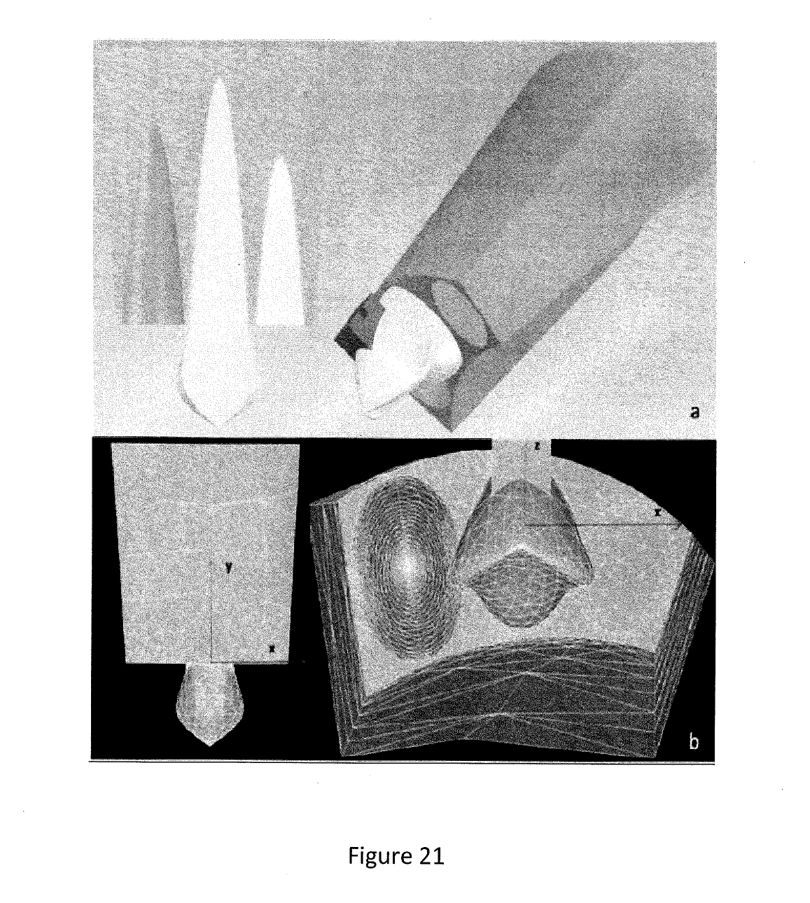

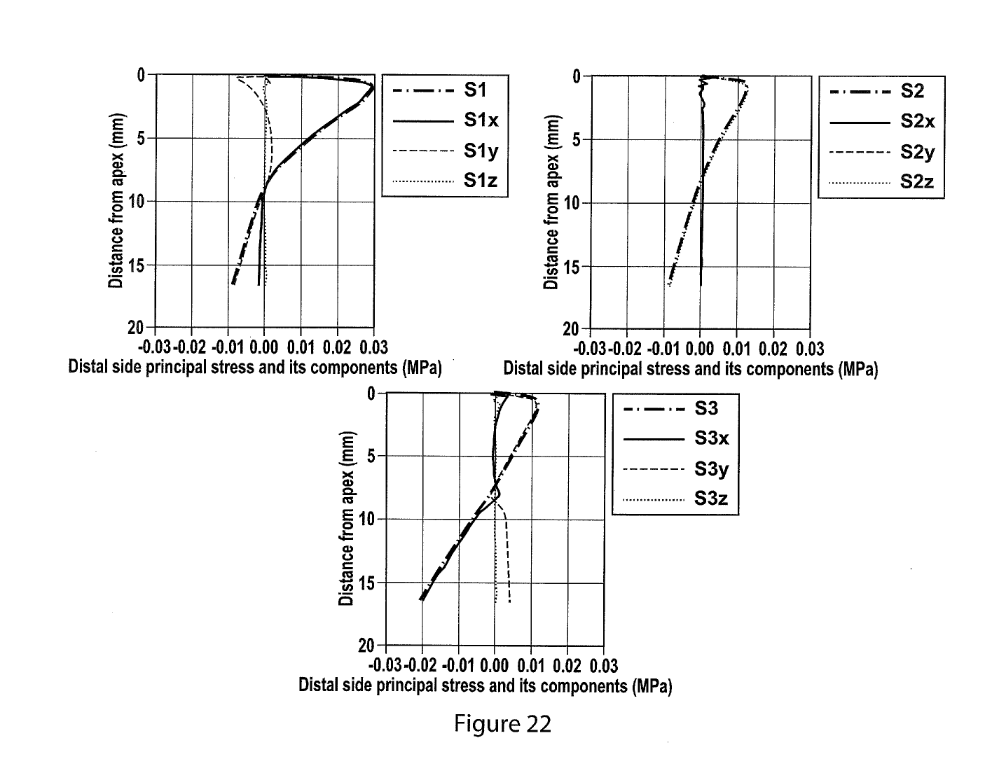

FIGS. 21 and 22 show sample diagrams and graphs of finite elements analysis used to show PDL stresses during tipping of a tooth.

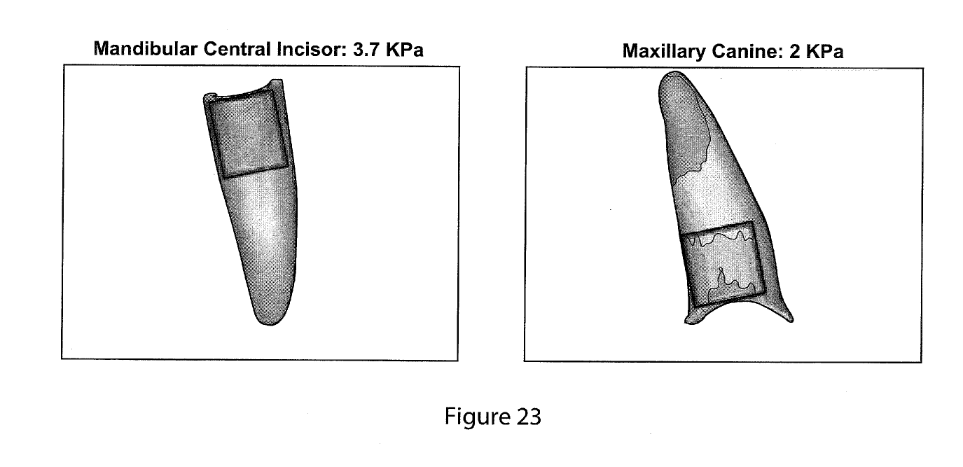

FIG. 23 shows example diagrams showing the results of FEA stress analysis on mandibular central incisor and maxillary canine.

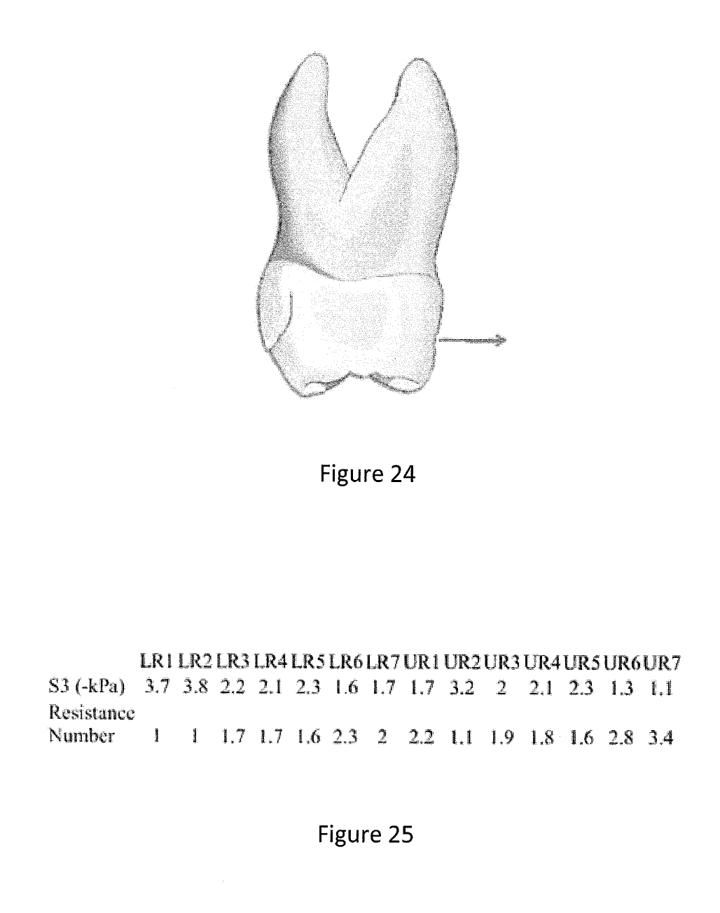

FIG. 24 shows a drawing of a load applied to a direction on the tooth.

FIG. 25 shows the results of stress analysis of the load applied to the tooth as shown in FIG. 24.

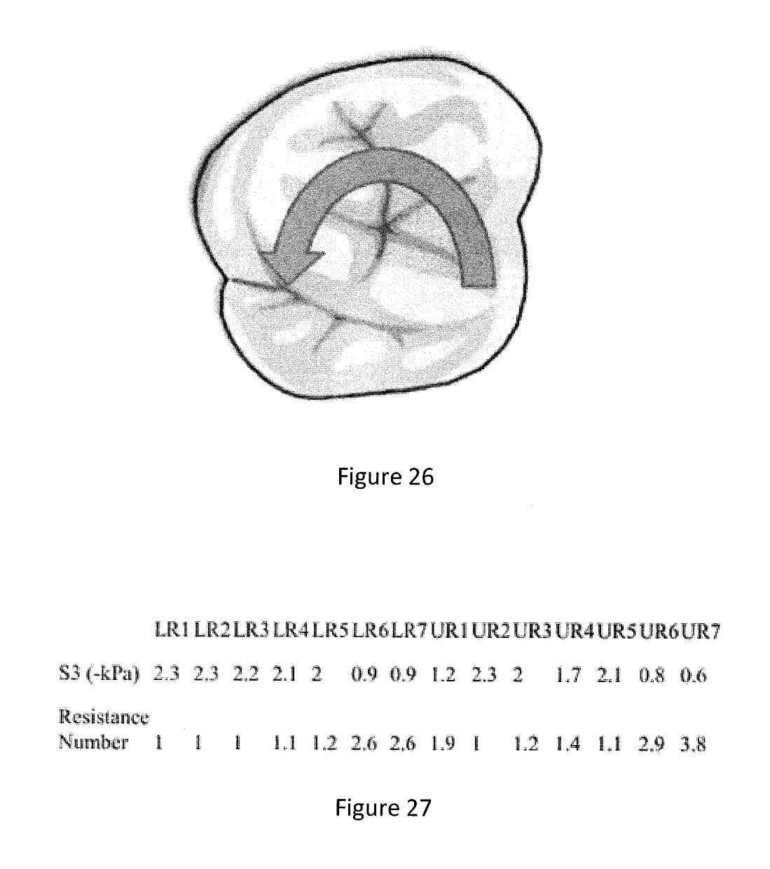

FIG. 26 shows a drawing of a load applied as a moment perpendicular to the OP.

FIG. 27 shows the results of stress analysis of the load applied to the tooth as shown in FIG. 26.

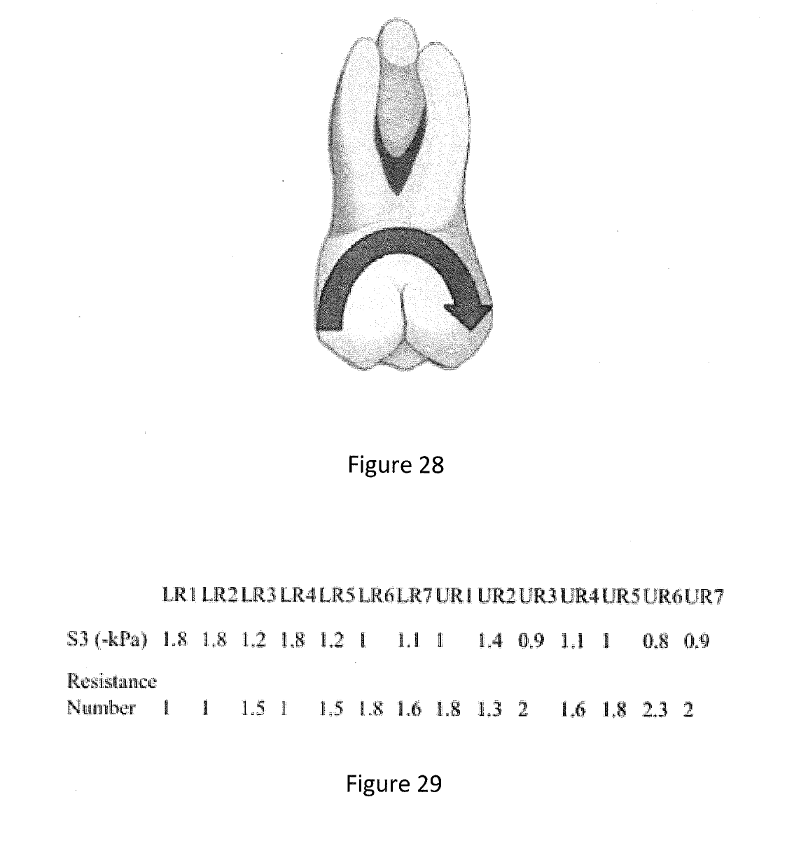

FIG. 28 shows a drawing of a load applied as distal crown tipping moment.

FIG. 29 shows the results of stress analysis of the load applied to the tooth as shown in FIG. 28.

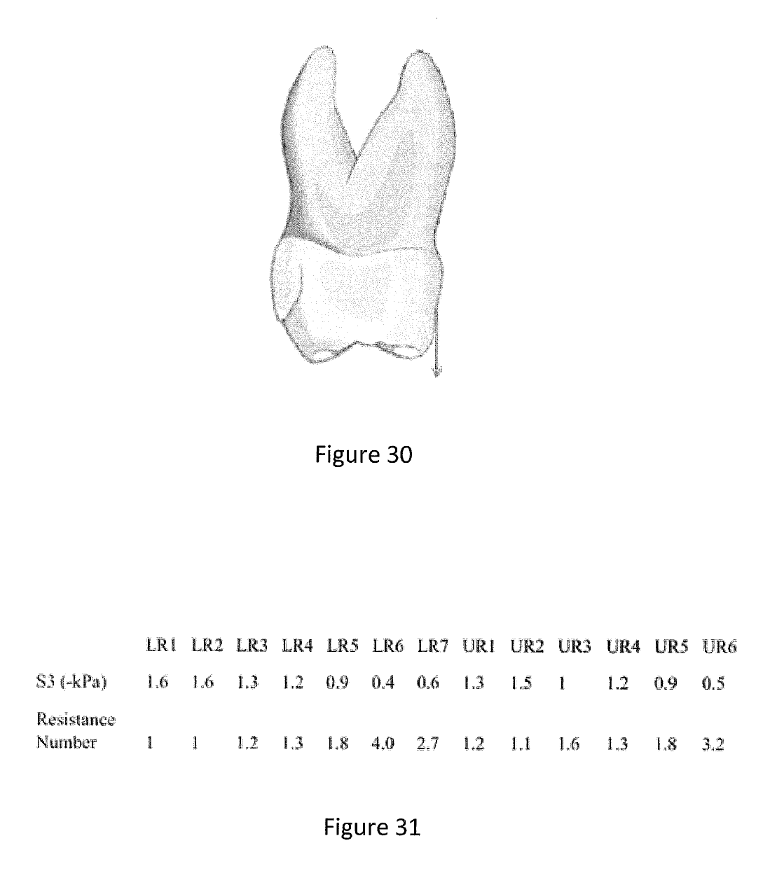

FIG. 30 shows a drawing of a load applied as extrusion force.

FIG. 31 shows the results of stress analysis of the load applied to the tooth as shown in FIG. 30.

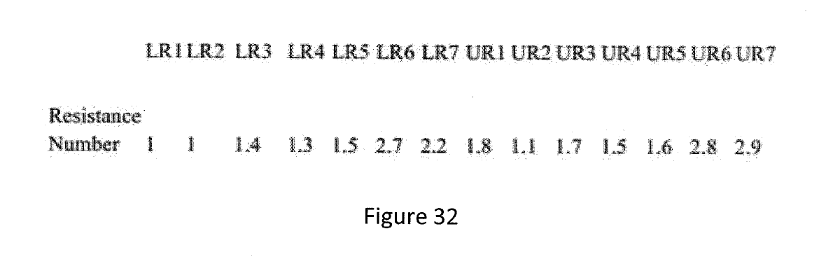

FIG. 32 shows average of some load scenarios.

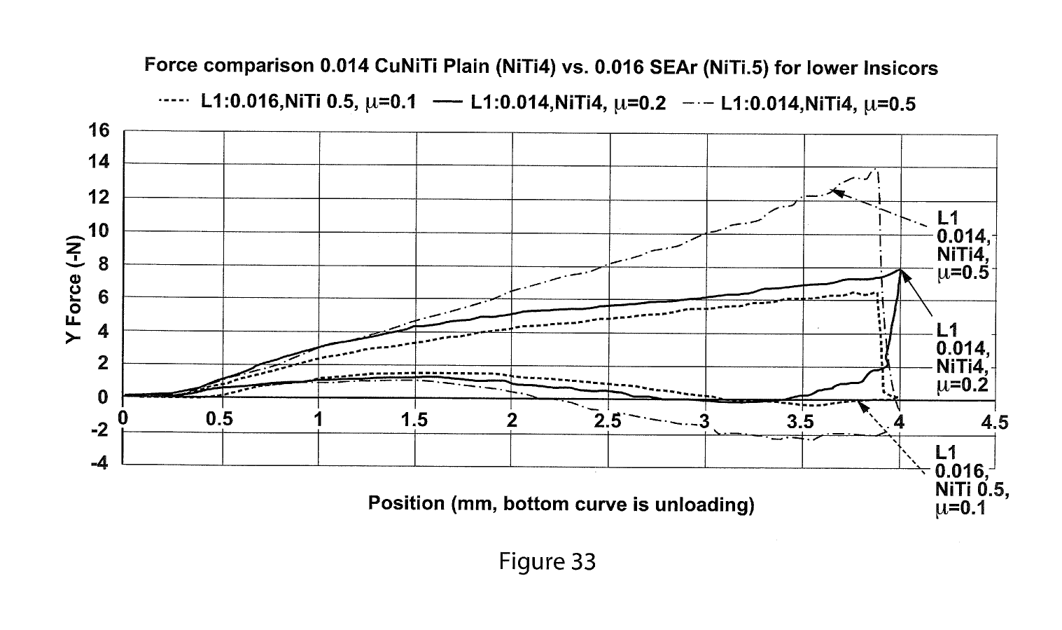

FIG. 33 shows a force comparison.

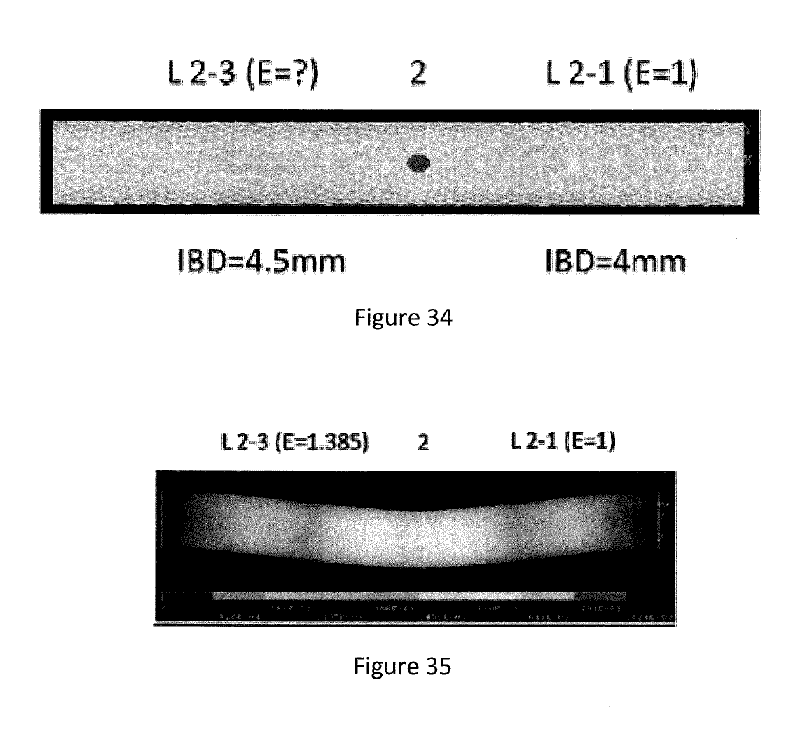

FIGS. 34 and 35 shows a sample graph showing force comparison of different archwires used on a tooth.

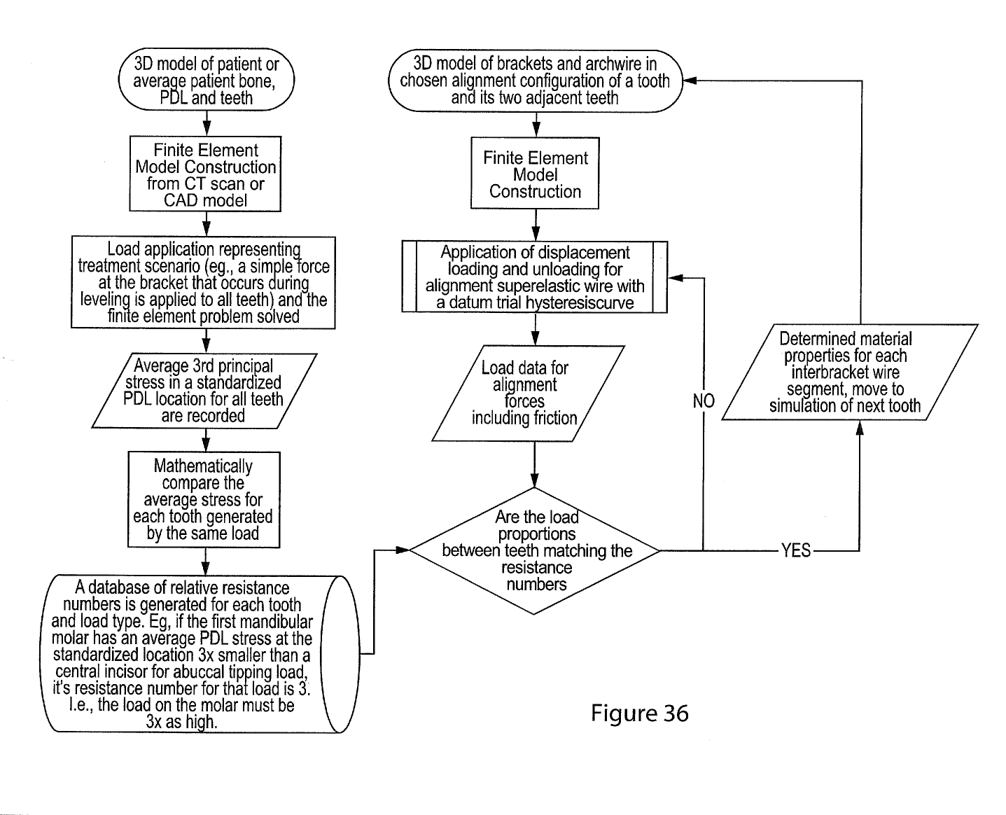

FIG. 36 shows a process of optimizing force proportions across teeth.

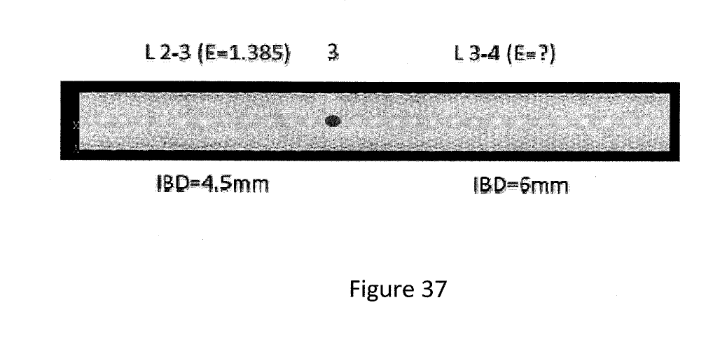

FIG. 37 shows a simulation.

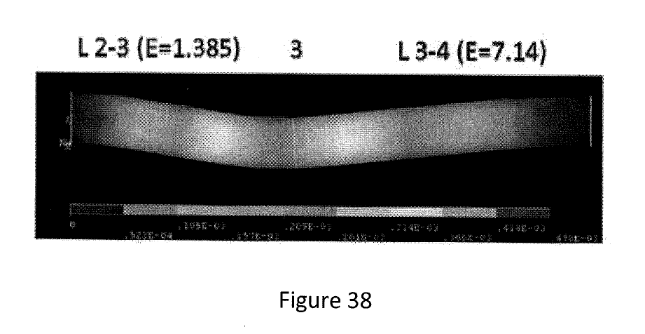

FIG. 38 shows a result.

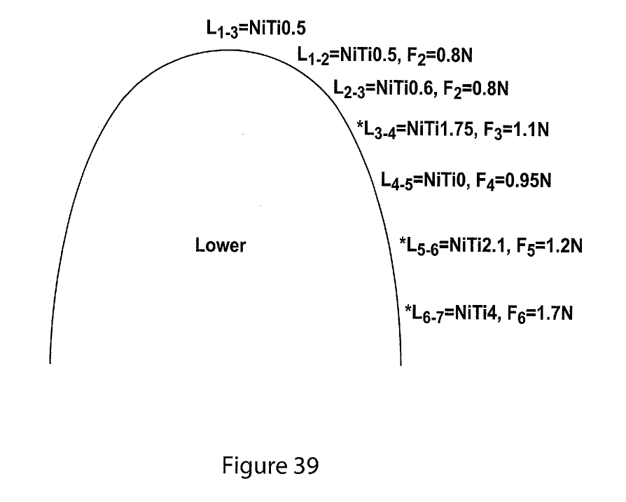

FIG. 39 shows individual NiTi material numbers.

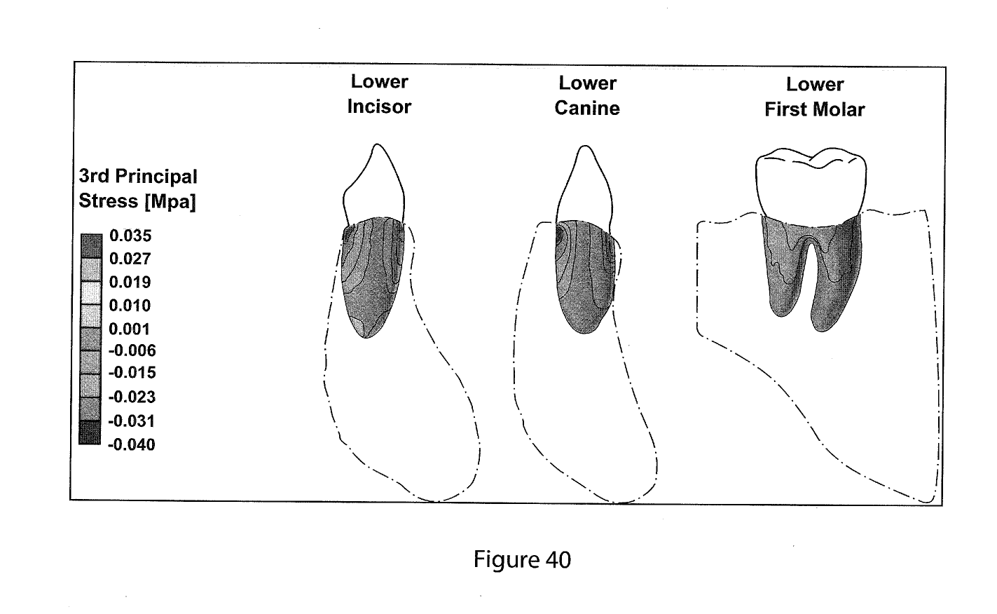

FIG. 40 shows stress for different teeth.

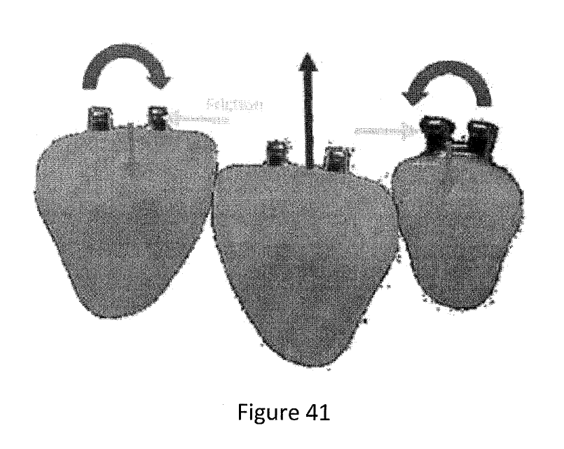

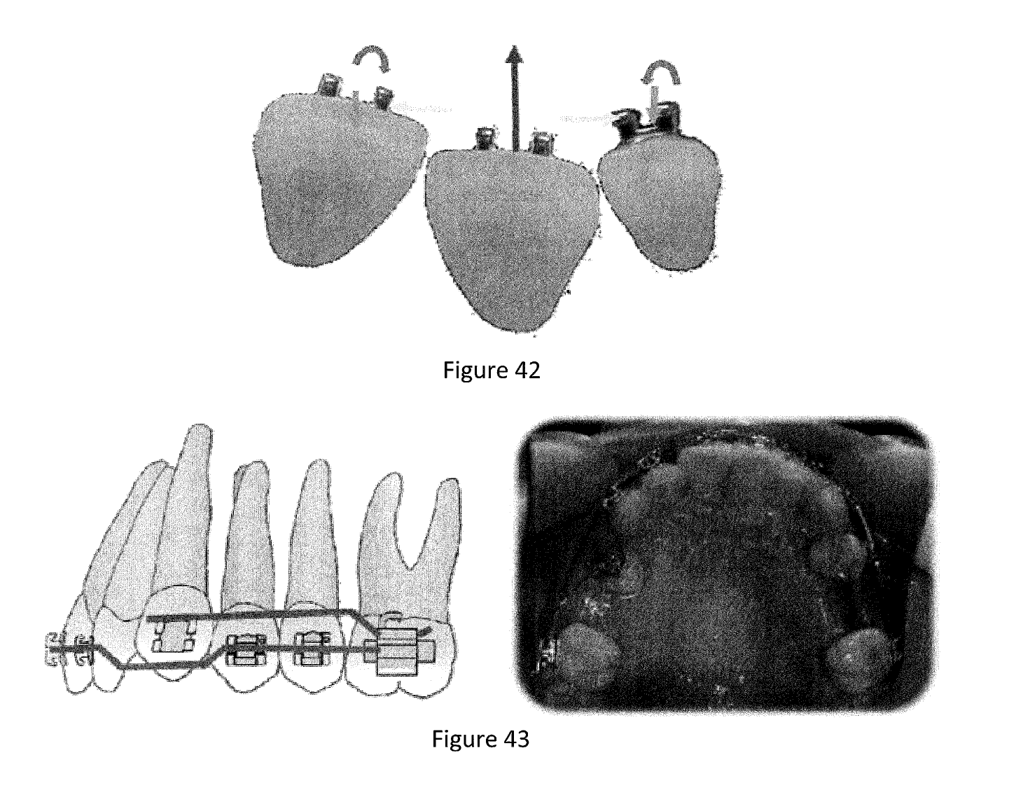

FIGS. 41 and 42 illustrate adjacent teeth being moved (e.g., rotated) according to methods and systems discussed herein to provide space.

FIG. 43 shows stiffer areas.

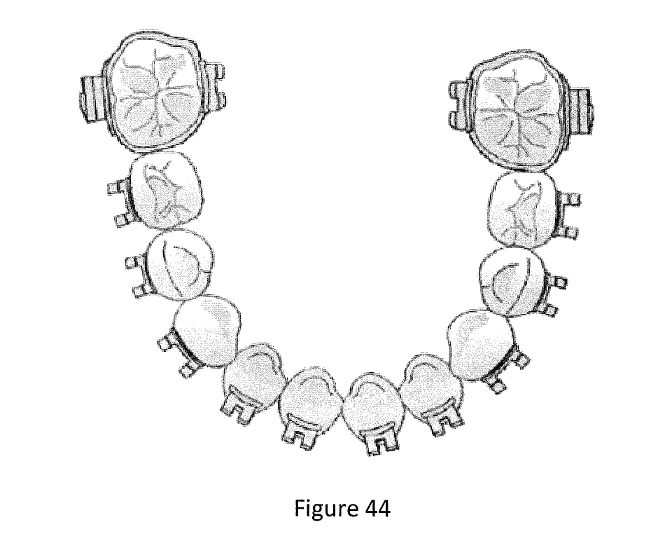

FIG. 44 shows angle edgewise appliance

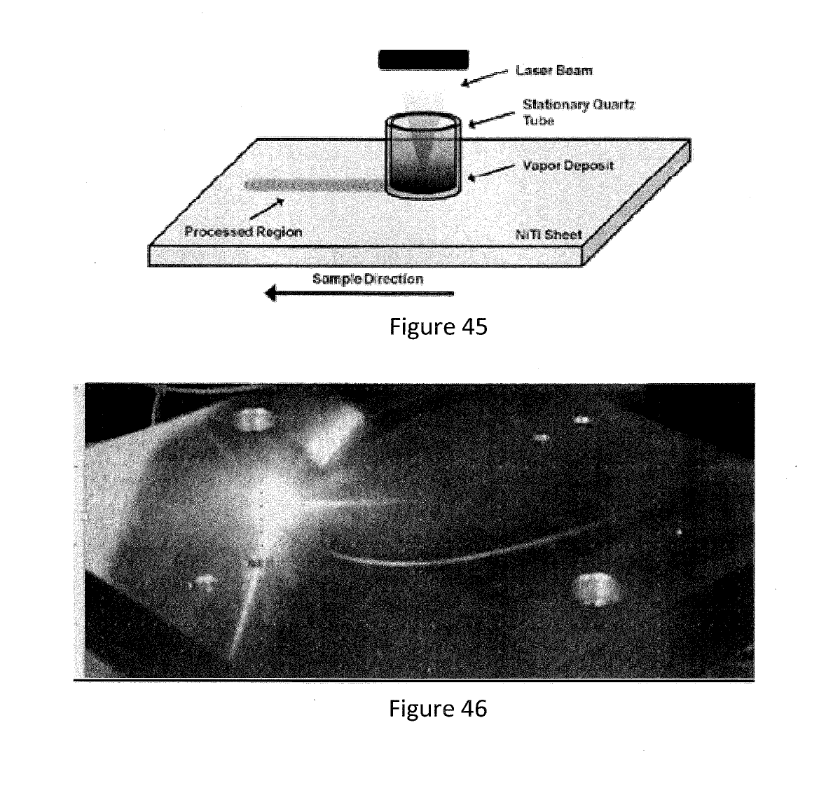

FIGS. 45 and 46 shows a Nd:YAG (neodymium-doped yttrium aluminum garnet) laser can be used to process the wire.

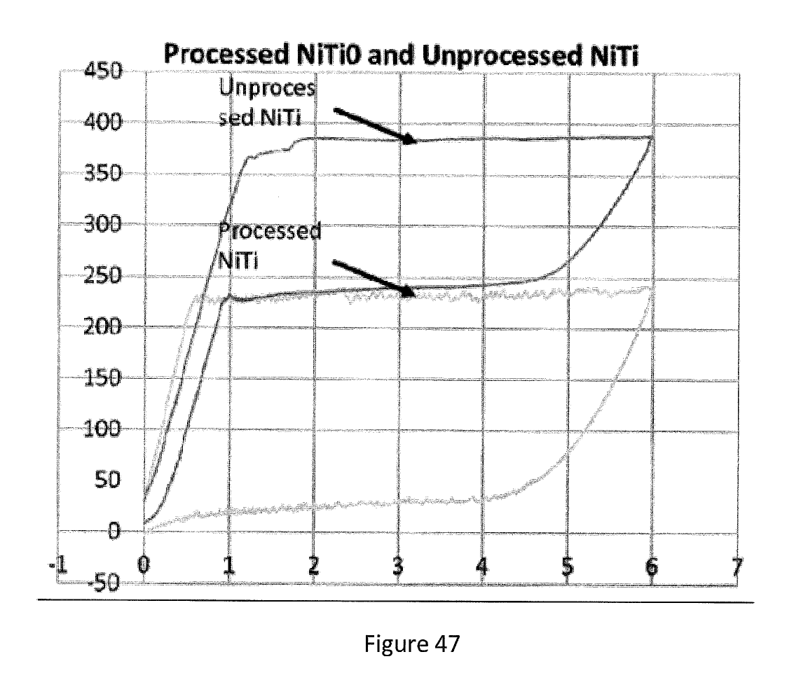

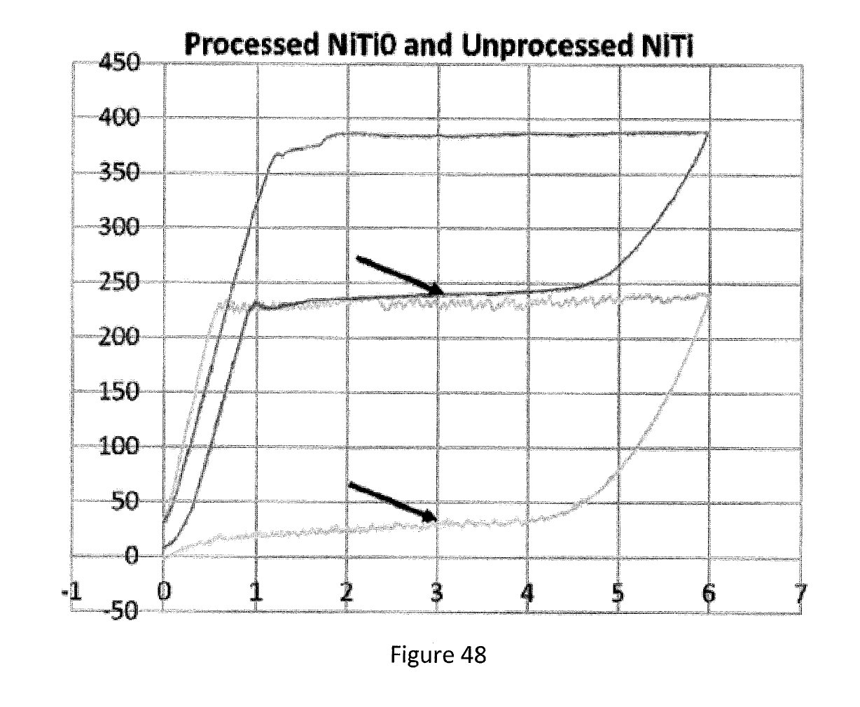

FIGS. 47 and 48 show graphs of NiTi processed and unprocessed.

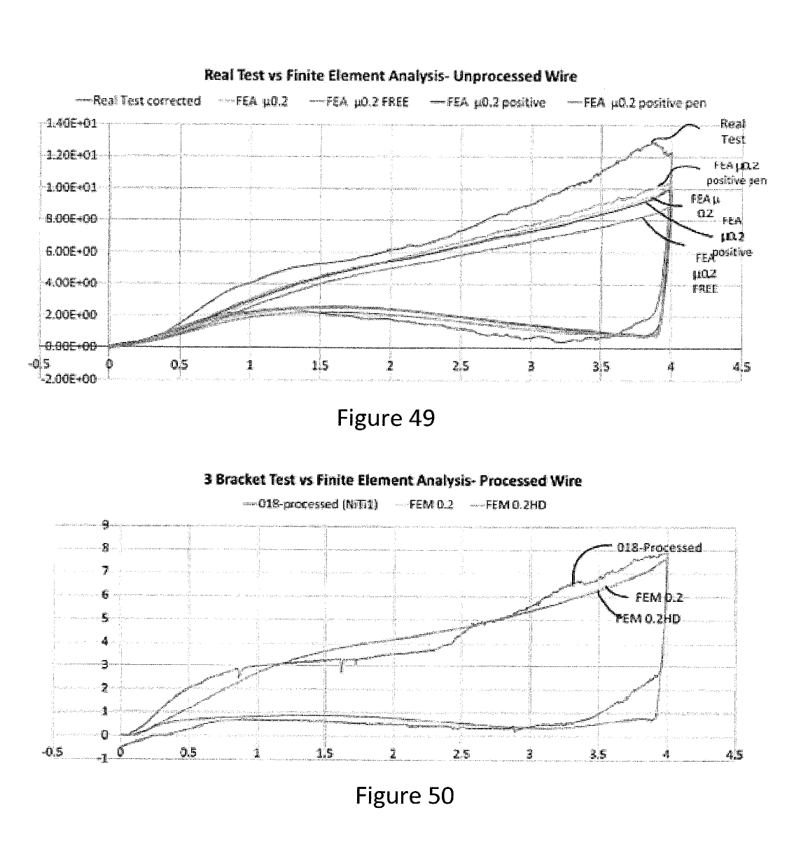

FIG. 49 is a graph showing the difference in results of analysis of an unprocessed wire subject to “real test”.

FIG. 50 is a graph showing the difference in results of analysis of NiTil wire subject to 3 bracket test (0.018-processed) versus FEA modeling (FEM 0.2, FEB 0.2HD) for a processed wire.

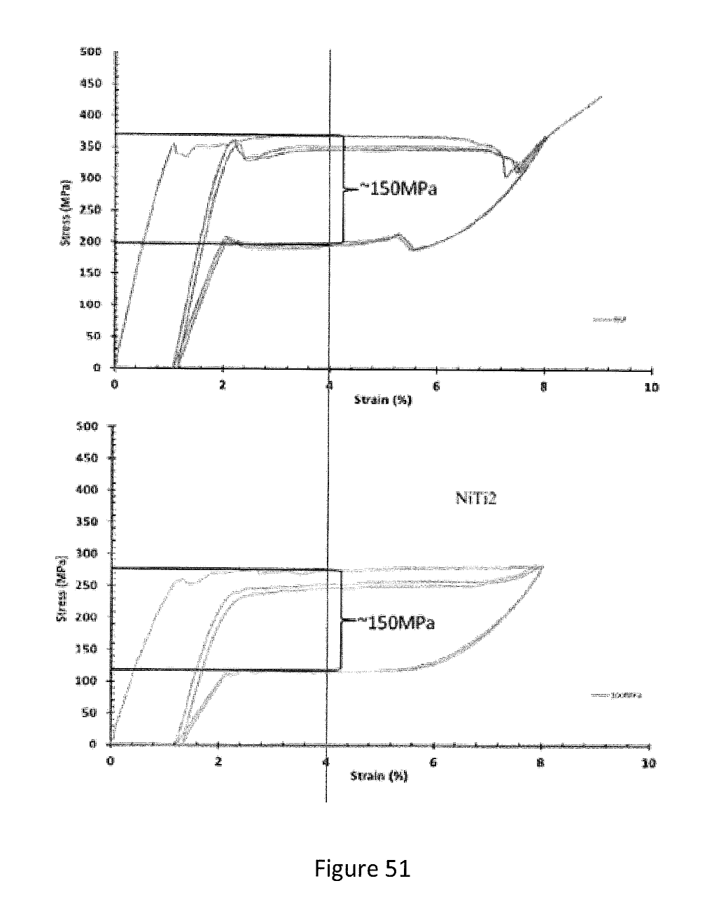

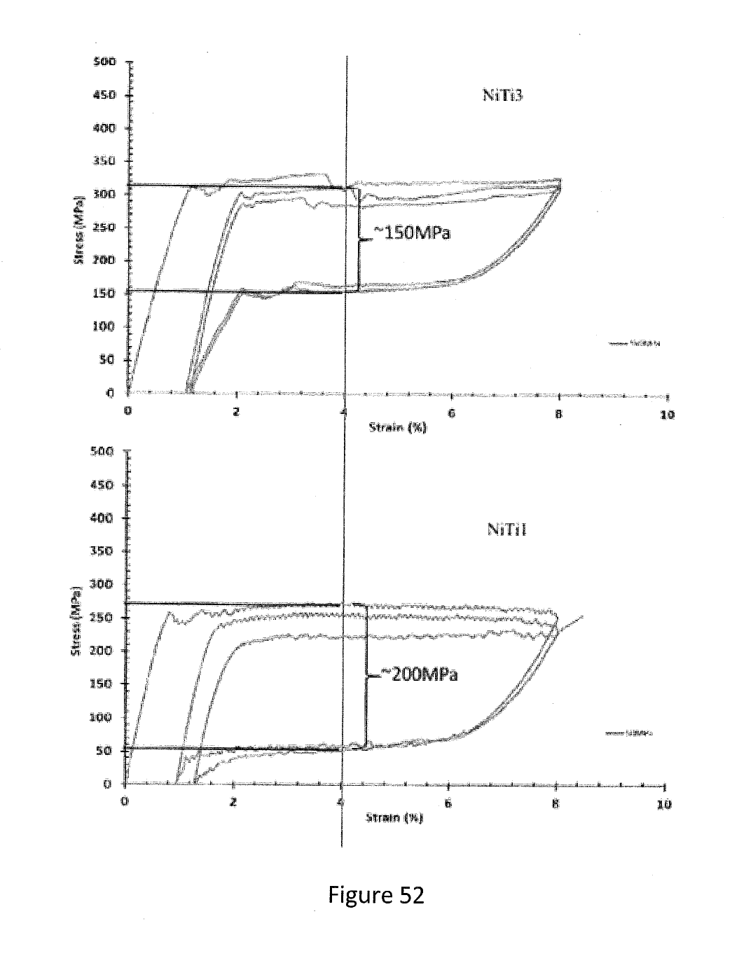

FIGS. 51 and 52 show various stiffness options for laser processed CuNiTi wires according to the system and methods disclosed herein.

### DETAILED DESCRIPTION

Programmed archwires may be used to achieve the following:

1. Controlled Load Magnitude: Better control of load levels for the target tooth using finite element analysis (FEA) based calculations.

2. Treatment Time: Often, an orthodontist needs to use a lower stiffness archwire because of severity of malocclusion in a specific area. Then, a second alignment archwire is needed to correct malocclusions of larger teeth, such as molars and premolars. The method described herein can allow an optimal approach of both the severe and mild to moderate malocclusions at the same time, which could potentially reduce alignment (treatment time) by, for example, a few weeks or months.

3. Chair Time: The orthodontist can reduce unwanted archwire changes and use programmed archwire to attack specific alignment problems in the arch.

4. Built-in Anchorage Strategy: Clinicians often use a “piggy-back”/2-archwire approach to minimize movement on adjacent teeth. This consists of a stainless steel (SS) archwire connecting anchorage teeth, with the addition of a nickel titanium (NiTi) wire to target the severe malocclusion area. The devices, systems and/or method described herein can allow this to be done in a single higher stiffness NiTi archwire (or other suitable material archwires). Desired diameters and stiffness can be obtained using Finite Elements Analysis (“FEA”).

5. Easiness of Clinical Insertion: The programmed low stiffness in strategic locations of the archwire can be used for ease of ligation. The programmed low stiffness can also be used to decrease change of bonding failures.

Currently, the International Organization for Standardization (ISO) standard for testing orthodontic wires utilizes three point bend testing, because the methodology to fully simulate wire testing in an environment that is clinically relevant would be impractical and time consuming to test wires on a routine basis. Manufacturers utilize data from this test to suggest the forces delivered by their archwires.

The suggested forces delivered by the archwire may be associated with a three point bending test that yields force values not accounting for a clinical situation, where a wire is engaged on brackets. Although theoretical calculations may be possible for certain materials such as stainless steel, accurate theoretical calculations can be challenging for nonlinear materials such as NiTi. For this reason, a numerical calculation approach (finite element analysis) can be used to properly calculate the loads. The disclosure made herein includes computer-simulated clinical conditions using a finite element model, validated with experimental data. Because clinical conditions can be modified with systematic precision on the computer-based model disclosed herein, a more realistic estimate of forces and adjustment of the model to yield desirable or predetermined force levels can be possible. The systems, devices, and/or methods herein can provide an orthodontist with an archwire which can have a realistic estimation and optimization of the forces required for an effective treatment.

### Customized Singular Archwire

The disclosed methods can be used to generate data that can illustrate pre-calculated stiffness modifications targeting specific clinical conditions such as high, low or ectopic canines, crowded incisors, rotated premolars, etc. The disclosed devices, systems, and/or methods can also be used to allow customization of archwire stiffness while taking into consideration inter-bracket distances, bracket slot size, magnitude of malocclusion, friction coefficients, extent of stiffness modification, wire diameter and/or cross-section.

The disclosed method can comprise simulating the above one or more clinical conditions using finite element analysis. Iterating one or more different variables can yield optimum, desired, or predetermined archwire stiffness, for example, for a specific region of the archwire for a specific patient. The optimum, desired, or predetermined archwire stiffness can be used to configure an archwire (e.g. by manufacturing an archwire with modified stiffness settings and/or modifying a pre-manufactured archwire) which can align the tooth with ease while the wire slides through adjacent brackets substantially without excess or undesirable restriction (e.g., friction forces below a predetermined level of restriction).

### Method of Optimizing Load and Anchorage

FIG. 2 shows an example block diagram for a method of optimizing stiffness of an orthodontic archwire with a computer system. The disclosed method can comprise a mathematical and systematic process to optimize load magnitude and anchorage requirements for tooth movement in a single archwire metallic alloy. The method can simulate one or more (e.g., predetermined relevant) clinical conditions leading to a loading and unloading force and moment during tooth alignment in a computer system. The disclosed method can be used to calibrate/design the archwire for a specific patient condition, such as a severe malocclusion.

Archwires can have modified stiffness that take into account clinical variables to calculate the force magnitude while optimizing anchorage of adjacent teeth. The disclosed method can calculate force magnitudes while optimizing anchorage of adjacent teeth.

The method can comprise, for example, 1) constructing a model of the malocclusion within a Finite Element Analysis software.

The method can comprise 2) inputting starting material properties into the software for one or more (e.g., predetermined or chosen) materials. The method can further comprise 3) conducting simulation of a standard material archwire using the FEA software. The user can record loads values in loading and unloading phases.

The method can further comprise 4) changing the material properties of the archwire within the FEA model. The material properties of the archwire can be iteratively and systematically changed to determine a desired or predetermined force to be applied on the target tooth by the archwire. For instance, in NiTi alloys, the height of the hysteresis plateaus can be decreased. Changing the material properties of the archwire can be used to optimize comfort of wire insertion for the orthodontist and/or to optimize a reasonable force level for the tooth. A reasonable force level reference, for example, can be postulated as about 0.010 inch diameter NiTi wire inserted in a lower incisor malocclusion with about 4 (millimeter) mm displacement; a reasonable force level reference can be postulated as about 0.012 inch diameter NiTi wire inserted in a lower incisor malocclusion with about 4 mm displacement; a reasonable force level reference can be postulated as about 0.014 inch diameter NiTi wire inserted in a lower incisor malocclusion with about 4 mm displacement; a reasonable force level reference can be postulated as about 0.004, 0.006, 0.008, 0.010, 0.012, 0.014, 0.016, 0.018, 0.020, 0.022, 0.024, 0.026, 0.028, 0.030, or 0.032 or more inch diameter NiTi wire, including the foregoing values and ranges bordering therein, inserted in a lower incisor malocclusion with about 1, 2, 3, 4, 6, 7, 8, 9, 10, 11, or 12 or more mm displacement, including the foregoing values and ranges bordering therein; a reasonable force level reference can be postulated as about 0.016 inch diameter NiTi wire inserted in a lower incisor malocclusion with about 4 mm displacement, including the foregoing values and ranges bordering therein. A reasonable force level reference, for example, can be postulated as about 0.010 inch diameter NiTi wire inserted in a lower incisor malocclusion with about 2 mm displacement; a reasonable force level reference can be postulated as about 0.012 inch diameter NiTi wire inserted in a lower incisor malocclusion with about 2 mm displacement; a reasonable force level reference can be postulated as about 0.014 inch diameter NiTi wire inserted in a lower incisor malocclusion with about 2 mm displacement; a reasonable force level reference can be postulated as about 0.016 inch diameter NiTi wire inserted in a lower incisor malocclusion with about 2 mm displacement, including the foregoing values and ranges bordering therein.

For other teeth, the force level can be proportionally adjusted to be equivalent. Proportionally adjusting the force level can comprise, for example, using a dentoalveolar complex computer model as exemplified in Rodrigo F. Viecelli, Effects of Initial Stresses and Time on Orthodontic External Root Resorption, J Dent Res 92(4): 346351 (2013), which is incorporated herein by reference and made a part of this specification.

The method can further comprise 5) repeating the process 1) to 4) above for different configurations of the system. Different system configurations can include, for example, interbracket distance, malocclusion magnitude including rotation of the target tooth, bracket slot size, wire size, teeth size (e.g., target tooth size), and extent of stiffness modification treatment on the wire. The method can further comprise 6) comparing specific patient malocclusion to data from different scenarios. A user can compare specific patient malocclusion to data from different scenarios (e.g., patient database) to, for example, determine an optimum, desired, or predetermined stiffness profile to be chosen for a specific patient case.

FIG. 3 shows an example drawing of an experimental setup for calibrating a finite elements model having three brackets. The method can comprise calibrating a finite element model by using an experimental setup. The experimental setup can comprise using a plurality of brackets, for example, three brackets as shown in FIG. 3. The experimental setup 200 can comprise one or more mobile element 210, one or more static elements 220, and brackets 230, 235. The one or more brackets 230 can be fixedly attached to the static elements 220. The one or more brackets 235 can be fixedly attached to the mobile element 210. The mobile element 210 can translate in a desired direction (e.g., vertical direction) to move the bracket 230 and induce a force (and resulting stresses and/or strains) on the archwire as discussed herein.

FIGS. 4A and 4B show photographs of the experimental setup 200 of FIG. 3 having an archwire 240 inserted in the brackets 230, 235. Above relative measurements of the movement range of the mobile element 210 and spacing between static elements 220 are shown in centimeters. For example, the movement range of the mobile element 210 can correlate and/or simulate to distance of the malocclusion bracket of a specific patient. The pacing between the static elements 220 can correlate and/or simulate interbracket distance (e.g., between anchor teeth and/or maloccluded tooth and the anchor teeth) in the specific patient

FIG. 5 shows a schematic model of the experimental setup 200 of FIG. 3. The experimental setup 200 can be used for a 3 bracket finite elements simulation (e.g., where the archwire slides relative to one or both of the brackets 230 as the bracket 235 moves in, for example, a substantially vertical direction, when a force is applied at point 255).

FIG. 6 shows the model of the experimental setup 200 of FIG. 3 with a force 250 applied. The force 250 can cause the archwire 240 to slide 260 in response to movement of the bracket 235. The archwire 240 can slide relative to the one or more brackets 230. For example, one end or portion 245 of the archwire 240 can slide relative to the corresponding (e.g., proximate or closest) bracket 230, while the other end or portion 246 remains substantially stationary (e.g., does not move) relative to the corresponding (e.g., proximate or closest) bracket 230. By sliding relative to the one or more brackets 230 that are on the static elements 220, additional high strain areas and friction forces can be reduced compared to 3-point bending where the archwire is fixed (e.g., does not translate or slide) relative to the brackets 230 as discussed and shown below in FIG. 7.

In some embodiments, both ends 245, 246 of the archwire 240 can slide relative to the corresponding brackets 230. In some embodiments, the archwire may translate (e.g., slide) relative to the bracket 235, including translating less relative to the bracket 235 then the ends of the 245, 246 translating relative to the corresponding brackets 230. For example, the archwire 240 may be stretched as the force 250 is applied. Accordingly, some or portions of the archwire 240 in the bracket 235 may slide out of the bracket 235 as the archwire 240 is stretched and moved.

FIG. 7 shows a schematic diagram of an example model of 3-point bending. The example model 300 can comprise static points 310 where the archwire does not translate (e.g., slide) relative to the static points 310. The archwire 340 bends in response to a 3-point bending force 350 and does not account for sliding across brackets (e.g., translate), as discussed herein and shown in FIG. 6. Using the 3-point bending model, three material stiffnesses may not translate to three force levels. Three point bending test may not simulate a clinical scenario with brackets. Interbracket distances may not be taken into consideration. Friction may affect clinical force as discussed herein and may be unrealistic in 3-point bending test. 3-point bending may be limited to material stiffness change of 3 times or portions.

FIG. 7 shows the various forces and discusses benefits that can be achieved with the systems and methods discussed herein.

Locally Softened Archwire

A more severe malocclusion can be present on a specific part of the dental arch, while other areas of the dental arch have mild malocclusions. The orthodontist often needs to choose a single low stiffness archwire that will address the severe malocclusion area, thus limiting efficiency in other areas of the dental arch where a higher stiffness wire would be optimal, because teeth are larger. Disclosed herein are devices, systems, and/or methods for calculating and/or optimizing the super elastic stiffness curve of the wire to achieve optimum, desired, or predetermined tooth movement according to force levels currently in use in the standard of care for certain teeth or portions of a dental arch. FIG. 8 shows different parts of the mouth in relation to forces on teeth.

Disclosed devices, systems, and/or methods include use of a starting archwire of a larger diameter that is locally softened (e.g. by reducing diameter) (to a predetermined or desired level and/or measurement) to allow effective movement of the teeth and convenient archwire insertion in the target area (e.g., area of severe malocclusion). A high stiffness can be maintained in other areas of archwire corresponding to certain portions of the dental arch where no movement or minor movement is needed for the teeth. The disclosed devices, systems, and/or methods can allow the orthodontist to customize the stiffness of the alignment archwire in a specific area of the dental arch that contains a severe malocclusion.

Optimizing archwire stiffness can be related to the force(s) to be applied to the target tooth (e.g. with a severe malocclusion). For example, the force(s) on the tooth can be related to the size of the target tooth. The force(s) can be related to the difference in size between the target tooth (e.g. canine) and the surrounding or achor tooth (e.g. incisor).

The archwire can be optimized to reduce difficulty in installing the archwire to the patient's teeth. For example, the archwire can be optimized such that the shape, size, and/or location of the target tooth does not block or cause excessive friction between the bracket on the target tooth and archwire when being installed to the patient.

FIG. 9 shows an example schematic diagram of an archwire having a soft section and a stiff section. The archwire 100 can comprise a soft section 110 (e.g., a first section), a first stiff section 120a (e.g., a second section), and a second stiff section 120b (e.g., a third section). The soft section 110 can comprise a first stiffness (e.g., associated with a first thickness or diameter of the archwire). The first stiff section 120a can comprise a second stiffness (e.g., associated with a second thickness or diameter of the archwire) great than the first stiffness. The second stiff sections 120b can comprise a third stiffness (e.g., associated with a third thickness or diameter of the archwire) great than the first stiffness. The second stiffness (e.g., diameter of the archwire) can be substantially equal to the third stiffness (e.g., diameter of the archwire). The first, second, and/or third stiffnesses can be made different by, for example, chemical treatment and/or different cross-sectional shapes and/or dimensions, etc. For example, dashed lines 130 illustrate the soft section 110 in FIG. 2 as having a smaller cross-section (e.g., smaller diameter) relative to the stiff sections 120a,b.

The soft section 110 can be located on, near, or proximate to a problem area (e.g. severe malocclusion or one or more target teeth) of a patient to treat the problem area. The stiff section 120 can be located on or near an anchoring area (e.g. areas without malocclusions and/or areas with relatively mild malocclusions such as surrounding or reactive teeth).

For example, a bracket placed on the severe malocclusion tooth can have a distance of about 6 mm from a bracket placed on a surrounding tooth corresponding to the first section 120a. The bracket of the severe malocclusion tooth can have a distance of about 8 mm from a bracket placed on a surrounding tooth corresponding to the second section 120b. Accordingly, the forces (e.g., rotation and pull forces) applied on the severe malocclusion tooth can be different because of the two different distances of the surrounding teeth (and correspondingly the brackets attached to the teeth). To mitigate undesired forces (e.g., rotation forces) that can be applied because of the varying interbracket distances, the soft section 110 can have a varying first stiffness. For example, the soft section 110 can have relatively stiffer portions for the 6 mm interbracket distance (e.g., proximate to the first stiff section 120a) relative to portions of the 8 mm interbracket distance (e.g., proximate to the second stiff section 120b). Stated differently, the first section 110 of the archwire 100 can have portions relatively softer for the 8 mm interbracket distance (e.g., proximate to the second stiff section 120b) relative to the 6 mm interbracket distance (e.g., proximate to the first stiff section 120a). The stiffness of the first section 110 may gradually or continuously change between the brackets (e.g., throughout the interbracket distances). The different stiffness of the soft section 110 may be achieved by varying the treatment (e.g., to reduce the diameter) applied to the soft section 110 as discussed herein. For example, the 6 mm interbracket distance of the soft section 110 may have relatively less treated (or untreated) portions as discussed herein relative to the 8 mm interbracket distance of the soft section 110.

### Method of Treating Larger Activations (e.g., Interbracket Distances)

FIG. 10 shows an example drawing of archwire having a soft section and a stiff section inserted to a slot of a bracket on the maloccluded tooth.

FIG. 11 shows a graph showing difference in behavior of a 3D archwire with processed canine region having different activations (e.g. 4 mm and 5 mm) A user may prescribe an archwire using data, such as data on archwire behavior based on maloccluded tooth activation. Accordingly, interbracket distance can be taken into consideration while choosing stiffness and diameter of the wire at a segment.

FIG. 12 shows a schematic model drawing of a 3D archwire inserted to a slot of a bracket. A user may mount the archwire to the slot of the bracket for certain ranges of malocclusions, e.g. for maloccluded tooth with smaller activations.

FIG. 13 shows a schematic model drawing of a 3D archwire simulating a larger activation. For maloccluded teeth requiring larger interbracket distance, lower moments and lower forces (e.g., normal forces) at adjacent brackets can be used to decrease friction to allow for sliding at larger activations.

To decrease friction to allow for sliding at larger activations, a user may ligate the archwire at the bottom of the bracket instead of on the slot. FIG. 14 shows a graph comparing the archwire ligated to the bottom of the bracket versus the archwire ligated to the slot. As shown on FIG. 14, ligation at bottom of bracket can be easier (loading) but clinical forces can be similar at 4mm. Lower friction can increase unloading force to achieve similar unloading forces at 4 mm In some embodiments, for severe canine displacements, a user may ligate from a distance from the bracket.

### Modified Stiffness Archwire

The systems and methods described herein can include maintaining substantially full or desired/predetermined stiffness for the rest of the archwire, outside of portions of the archwire having modified stiffness. Maintaining full stiffness for the rest of the archwire can allow maintaining an enhanced anchorage (to substantially prevent or inhibit unnecessary movement of reactive teeth, for example) while simultaneously achieving optimum, desired, or predetermined tooth movement.

The archwire can be optimized such that the forces to the target tooth are in normal clinical levels. The difference in stiffness between the target tooth area and the rest of the wire can be optimized or maximized to a desired or predetermined setting or level.

Archwire with Optimized Force Proportions across Teeth

Force proportions for lateral movement relative to the lower incisor can be as follows: Lower: 1 (incisors), 1.3 (canine+prem), 2 (molars); Upper: 1.4 (central), 1.3 (lateral), 1.4 (canine), 1 (premolars), 2.4 (molars). Disclosed herein are methods that account for various loads and pressures to the tooth to optimize force proportions across substantially all, most, or some teeth by using variables and methods of calculations to improve accuracy over the approach and data as, for example, discussed above.

Numerical studies in the field show that stresses are not the same in all directions inside the periodontal ligament (PDL) during tooth movement. In the PDL, “hydrostatic pressure” can be represented by the average of the 3 principal stresses.

FIG. 17 shows that blood pressure can vary from 1.3 to 4 KPa in capillaries and 4 to 15 KPa in arterioles. Arterioles and capillaries are present in the PDL. PDL vessels can run occluso-apically.

FIG. 18 shows that even when hydrostatic PDL stress (average of three principal stresses) is zero, ischemia can still occur.

3D stresses can be simplified by “diagonalizing” the matrix and transforming a general state of stress in 3 normal stresses. FIG. 19 illustrates simplified 3D stresses.

FIG. 20 shows an example drawing of an archwire having optimized force proportions across substantially all, most, or some teeth. Modifying an archwire to optimize force proportions across substantially all, most, or some teeth can comprise simplifying 3 rd Principal Stresses (“3D stress”) to the teeth.

The 3D stress σ3 can be the minimum or 3 rd principle stress, while the 1 st principal stress a1 can be the maximum principal stress, and the 2 nd principal stress σ2 can be the middle principal stress. A user may determine the principal stresses in a point in the tooth, PDL, or bone by using finite elements analysis.

FIGS. 21 and 22 show sample diagrams and graphs of finite elements analysis used to show PDL stresses during tipping of a tooth.

In designing the archwire, Finite Element Analysis (FEA) can be used. FEA can be used to calculate “resistance factors” of the tooth-PDL-bone complex to different tooth movements based on average teeth with realistic morphology. These “proportions” between teeth may not be absolute numbers. The effect of interbracket distances on archwire design can also be used to design the archwire.

To quantify the results, the 3 rd Principal Stress (most negative or most compressive) can be selected based on the 2 following principles: 1) If compression exists, the most compressive stress may have the highest chance to cause PDL necrosis which will limit tooth movement. 2) In the absence of necrosis, the rate of bone resorption, which occurs in areas of high compression, may determine tooth movement.

FIG. 23 shows example diagrams showing the results of FEA stress analysis on mandibular central incisor and maxillary canine.

FIG. 24 shows a drawing of a load applied to a direction on the tooth. FIG. 25 shows the results of stress analysis of the load applied to the tooth as shown in FIG. 24.

FIG. 26 shows a drawing of a load applied as a moment perpendicular to the OP. FIG. 27 shows the results of stress analysis of the load applied to the tooth as shown in FIG. 26.

FIG. 28 shows a drawing of a load applied as distal crown tipping moment. FIG. 29 shows the results of stress analysis of the load applied to the tooth as shown in FIG. 28.

FIG. 30 shows a drawing of a load applied as extrusion force. FIG. 31 shows the results of stress analysis of the load applied to the tooth as shown in FIG. 30.

FIG. 32 shows average of some load scenarios. FIG. 33 shows a force comparison.

As shown above, load proportions (resistance numbers) to obtain uniform PDL stress in each tooth can vary according to the type of load. Some known estimations of load proportions can be off by up to 70% in posterior teeth and 30% on anterior teeth, which the systems and methods discussed herein address and optimize.

FIGS. 34 and 35 shows a sample graph showing force comparison of different archwires used on a tooth. As shown, the force increases with the as the friction coefficient (e.g., resistance to sliding as discussed herein) increases.

The algorithm can comprise finding the E in the segment distal to L1 until the displacement ratio of L2 compared to L1 (for the same force) is matched. The average malocclusion can be considered to be 4 mm The bending stiffness for L2 can be equal to L1, even though they may have different IBDs on each side. Since the IBD L2-3 is higher, a higher E is required to compensate. FEA can arrive at how much higher the E has to be for the L2-3 archwire segment.

Optimization of the archwire can comprise taking into consideration IBDs and changing the material at each, most, or some interbracket distance until the ideal, desired, and/or predetermined force proportion is achieved between substantially all, most, or some teeth, starting for example from lower incisors. FIG. 36 shows a process of optimizing force proportions across teeth,

Having found the E for L2-3, the E for the L3-4 segment can be calculated so that, for the same wire force, L3 gets the correct tooth proportions as determined the research described herein.

FIG. 37 shows a simulation. FIG. 38 shows a result. FIG. 39 shows individual NiTi material numbers.

Desigining Archwire with Modified Stiffness

In designing an optimized archiwire, interbracket distance may be taken into consideration while choosing stiffness and diameter of the wire at a segment.

Optimizing orthodontic alignment with the edgewise appliance may include each tooth to be under similar periodontal stress. FIG. 40 shows stress for different teeth.

Optimizing orthodontic alignment with the edgewise appliance may include that the archwire be free to slide during movement of interest and have enough or sufficient (e.g., predetermined or desired) force to open space by moving adjacent teeth if tooth is crowded.

FIGS. 41 and 42 illustrate adjacent teeth being moved (e.g., rotated) according to methods and systems discussed herein to provide space.

Archwire may include maximum acceptable stiffness in areas where movement is not desirable. FIG. 43 shows stiffer areas.

Known design for angle edgewise appliance can be based on crown morphology, convenience and the “ideal arch” philosophy which can result in illogical force profile during alignment. FIG. 44 shows angle edgewise appliance. Methods described herein introduces design based on biomechanics to address following issues: 1) Large IBDs on canines and molars 2) Small IBDs on incisors 3) Uniform stiffness archwire, etc.

Methods described herein can be used to achieve the following: 1) Optimum wire 0.018 CuNiTi for maximum anchorage of adjacent teeth, 2) Maximum processing of interbracket regions with NiTiO stiffness (10× decrease in martensitic plateau), 3) Forces similar or lower than a 0.014 plain wire at the canine, 4) Maximum activation recommended of 4 mm for bracket insertion to allow substantially free sliding during alignment, etc. For larger activations, tying the wire with a ligature to the bottom of the bracket can be used to allow for free sliding and minimize side effects.

Processing Archwire with Modified Stiffness

FIGS. 45 and 46 shows a Nd:YAG (neodymium-doped yttrium aluminum garnet) laser can be used to process the wire. The laser can reduce the height of the martensitic and austenitic transformation curves. FIGS. 47 and 48 show graphs of NiTi processed and unprocessed.

Using the disclosed systems and methods can prescribe change in the stiffness of segments of superelastic wire with 2 micrometer resolution without making bends. The method can decrease loading plateau by about 1.5 times to about 2 times. The method can decrease unloading plateau by about 8 times to about 10 times.

FIG. 49 is a graph showing the difference in results of analysis of an unprocessed wire subject to “real test” (e.g. three bracket test described above) versus FEA modeling (FEA i0.2, 0.2 FREE, 0.2 positive, positive pen) for a processed wire. The graph displays the magnitude of force (e.g., Newtons) along the Y-axis and the position (e.g., distance) on X-axis, which may correlate to magnitude of malocclusion.

FIG. 50 is a graph showing the difference in results of analysis of NiTil wire subject to 3 bracket test (0.018-processed) versus FEA modeling (FEM 0.2, FEB 0.2HD) for a processed wire. FIGS. 49 and 50 show that force is increased for a processed wire relative to an unprocessed wire for a given position.

FIGS. 51 and 52 show various stiffness options for laser processed CuNiTi wires according to the system and methods disclosed herein.

I/we claim:

1. A method for optimizing stiffness of an orthodontic archwire for a tooth malocclusion of a patient with a computer system, the method comprising:
constructing a model of a patient's teeth in the computer system;
inputting material properties of the archwire to the computer system; and
determining an adjusted stiffness of a first section of the orthodontic archwire, the first section associated with the tooth malocclusion of the patient.

2. The method as recited in claim 1, further comprising:
wherein the adjust stiffness is determined based on different variables associated with the patient's teeth.

3. The method as recited in claim 2, wherein the variables comprise at least one of interbracket distance, malocclusion magnitude, bracket slot size, wire size, teeth size or extent of stiffness modification of the archwire.

4. The method as recited in claim 1, wherein the adjusted stiffness is determined based on a comparison of the model of the patient's teeth to a patient database comprising data for addressing tooth malocclusions.

5. The method as recited in claim 1, further comprising constructing an archwire having the first section based on the adjusted thickness.

6. The method as recited in claim 1, wherein determining the adjusted stiffness comprises iteratively changing the material properties of the archwire in the computer system.

7. The method as recited in claim 1, further comprising reducing a diameter of the first section of the archwire relative to other portions of the archwire to soften the first section of the archwire relative to the other portions of the archwire.

8. The method as recited in claim 7, wherein the adjusted stiffness of the first section varies through an extent of the first section.

9. The method as recited in claim 1, wherein the archwire comprises a second section, the second section having a stiffness higher than the first section.

10. The method as recited in claim 9, wherein the archwire comprises a third section, the third section having a stiffness higher than the first section, wherein the first section is between the second and third sections.

11. The method as recited in claim 10, wherein a first portion of the adjusted thickness of the first section proximate to the second section is stiffer than a second portion of the adjusted thickness of the first section proximate to the third section.

12. The method as recited in claim 11, wherein an interbracket distance associated with the first portion of the first section is less than an interbracket distance associated with the second portion of the first section.

13. The method as recited in claim 10, wherein the stiffness of the second section is substantially same as the stiffness of the third section.

14. The method as recited in claim 1, wherein the adjusted stiffness is determined using finite element analysis in the computer system.

15. The method as recited in claim 1, wherein the patient's teeth comprise a problem area and an anchoring area, and the archwire is configured such that the first section is located on or near the problem area and the second section is on or near the anchoring area.

16. The method as recited in claim 1, wherein the archwire comprises a material of nickel titanium.

17. The method as recited in claim 1, wherein the stiffness of the archwire can be changed within 2 micrometer resolution without making any bends.

18. The method as recited in claim 1, wherein stiffness modification of the archwire reduces unloading plateau of the archwire from about 8 times to about 11 times.

19. The method as recited in claim 1, wherein stiffness modification of the archwire reduces loading plateau of the archwire from about 1.5 times to about 2.5 times.

20. The method as recited in claim 1, wherein constructing a model of a patient's teeth comprises calibrating a finite element model using a plurality of brackets.
